(19) United States
(12) Patent Application Publication
(10) Pub. No.: US 2009/0088340 A1
(43) Pub. Date: Apr. 2, 2009

(54) METHODS FOR PREDICTING THE REDUCTION/OXIDATION (REDOX) REACTION ACTIVITY OF METAL COMPLEXES

(75) Inventor: Jack S. Summers, Cullowhee, NC (US)

Correspondence Address: JENKINS, WILSON, TAYLOR & HUNT, P. A., Suite 1200 UNIVERSITY TOWER, 3100 TOWER BLVD.,, DURHAM, NC, 27707, US

(73) Assignee: WESTERN CAROLINA UNIVERSITY

(21) Appl. No.: 12/240,518

(22) Filed: Sep. 29, 2008

Related U.S. Application Data
(60) Provisional application No. 60/995,821, filed on Sep. 28, 2007.

(51) Int. Cl. C40B 30/08; G01N 31/10

(52) U.S. Cl. 506/11; 436/37

(57) ABSTRACT

The presently disclosed subject matter relates to methods of predicting or measuring the reduction/oxidation (redox) reaction-related reactivity of a metal complex, particularly with respect to the ability of the metal complex to catalyze or inhibit the generation of reactive oxygen species (ROS) in vivo. The presently disclosed subject matter further relates to methods of screening and/or developing drug candidates that can mediate metal complex-catalyzed ROS generation. More particularly, the presently disclosed methods involve the use of probes having NMR active nuclei that can interact with paramagnetic metals in ways that can be easily detected by nuclear magnetic resonance (NMR) spectroscopy.

### CROSS REFERENCE TO RELATED APPLICATIONS

This application claims the benefit of and priority to U.S. Provisional Patent Application Ser. No. 60/995,821, filed Sep. 28, 2007, the disclosure of which is incorporated herein by reference in its entirety.

### TECHNICAL FIELD

The presently disclosed subject matter relates to methods of predicting the reduction/oxidation (redox) reaction-related reactivity of metal complexes. In some embodiments, the methods can be used to predict whether, or to what extent, a metal/biomolecule complex can participate in catalyzing the generation of (or preventing the generation of) reactive oxygen species (ROS). The presently disclosed subject matter also relates to methods of screening drug candidates for their ability to mediate the ROS generation capacity of metal complexes and to methods of detecting chemical species in samples that have potential for participating in metal complex-catalyzed redox reactions. The methods relate to the use of nuclear magnetic resonance (NMR) active probes.

ABBREVIATIONS

| | |
|---|---|
| ALS = | amyotrophic lateral sclerosis |
| CPMG = | Carr-Purcell-Meiboom-Gill |
| DDC = | diethyl dithiocarbamate |
| DMSO = | dimethyl sulfoxide |
| D₂O = | deuterium oxide |
| EPR = | electron paramagnetic resonance |
| F⁻ = | fluoride anion |
| H₅DTPA = | diethylenetriamine-N,N,N′,N″,N″- |
| | pentaacetic acid |
| H₄β-EDDADP = | ethylenediamine-N,N′-diacetic acid-N, |
| | N′-dipropionic acid |
| H₄EDTA = | ethylenediamine-N,N,N′,N′- |
| | tetraacetic acid |
| H₂O₂ = | hydrogen peroxide |
| H₄PDTA = | propylenediamine-N,N,N′,N′- |
| | tetraacetic acid |
| HPLC = | high performance liquid |
| | chromatography |
| H₆TTHA = | triethylenetetraamine-N,N,N′,N″,N″′, |
| | N″′-hexaacetic acid |
| IC₅₀ = | 50% inhibitory concentration |
| M = | molar |
| mM = | millimolar |
| 2ME2 = | 2-methoxyestradiol |
| ms = | milliseconds |
| NMR = | nuclear magnetic resonance |
| O₂•⁻ = | superoxide anion |
| OH• = | hydroxyl radical |
| PMS = | phenazine methosulfate |
| ppm = | parts per million |
| QSAR = | quantitative structure activity |
| | relationship |
| R₂ = | transverse relaxation rate |
| RA = | rheumatoid arthritis |
| ROS = | reactive oxygen species |
| s = | seconds |
| SAR = | structure activity relationship |
| SOD = | superoxide dismutase |
| T₂ = | transverse relaxation time |
| tfa = | trifluoroacetate |

### BACKGROUND

Signs of oxidative stress are frequently seen in tissue samples of patients with a variety of diseases, including inflammatory diseases such as rheumatoid arthritis (RA) and atherosclerosis, and neurological diseases such as amyotrophic lateral sclerosis (ALS) and Parkinson's disease. In particular, iron is believed to participate in the initiation and progression of these diseases by catalyzing deleterious oxidation/reduction (redox) reactions. While many biomolecules normally bind metal ions in solution, they typically do so in ways that do not support the catalytic generation of reactive oxygen species (ROS). The identities of metal complexes that participate in diseases by catalyzing these reactions are generally unknown. In addition to participating in the generation of ROS, metal complexes can react with ROS or their precursors to mitigate oxidative stress. Notable among these are metal containing enzymes such as the superoxide dismutase (SOD) enzymes. SODs mitigate oxidative stress by catalyzing the destruction of superoxide ion. SODs are believed to be critical to the survival of many cancer cell types and have been proposed as potential targets for anticancer therapeutics. See Huang et al., Nature, 2000, 407, 390.

Accordingly, there exists a need for methods of predicting whether a given metal complex will participate in redox-related chemistry and to select drug candidates that can mediate such participation. More particularly, there exists a need for methods to detect, characterize, and/or quantify the likelihood of metal/biomolecule complexes to participate in the propagation or mitigation of deleterious oxidation reactions under biological conditions and to screen drug candidates for their ability to mediate the activities of such complexes, or to participate in such activities themselves.

### SUMMARY

The presently disclosed subject matter provides a method of predicting a redox reaction-related activity of a metal complex, said method comprising: providing a first test solution comprising a metal complex and a probe, wherein said probe comprises a NMR-active nucleus; and measuring a signal in the first test solution using NMR spectroscopy to determine a relaxation rate of the NMR-active nucleus, wherein said relaxation rate of the NMR-active nucleus corresponds to the accessibility of the metal atom in the metal complex to the test solution, thereby predicting the redox reaction-related activity of the metal complex.

In some embodiments, the method further comprises providing one or more additional test solutions, wherein each of the one or more additional test solutions comprises the probe and a different concentration of the metal complex; measuring a signal related to the probe in each of the one or more additional test solutions using NMR spectroscopy, thereby determining a relaxation rate for the NMR-active nuclei in each of the one or more additional test solutions; and comparing the relaxation rate measured for the NMR-active nucleus in the first test solution with the relaxation rate for the NMR-active nucleus in each of the one or more additional test solutions, thereby determining a sensitivity of the probe to a change in concentration of the metal complex.

In some embodiments, the probe is F⁻. In some embodiments, the probe comprises phosphorus.

In some embodiments, the metal complex comprises a ligand selected from the group consisting of a protein, a peptide, a carbohydrate, a nucleic acid, a lipid, a low molecular weight natural product, or a combination or a chemically-modified derivative thereof. In some embodiments, the metal complex comprises a paramagnetic metal ion.

In some embodiments, predicting the redox reaction-related activity of the metal complex predicts the ability of the metal complex to catalyze generation of or to prevent generation of ROS in one of a cell, a tissue, a biological fluid, and a subject. In some embodiments, the cell, tissue, biological fluid or subject is associated with a disease state. In some embodiments, the disease state is related to cancer, an inflammatory disease, a neurological disease, or an infection.

In some embodiments, a plurality of different test solutions is provided, each comprising a different metal complex, and the redox reaction-related activity of each different metal complex is predicted.

In some embodiments, the presently disclosed subject matter provides a method of predicting an effect of a drug candidate on the redox reaction-related activity of a metal complex, the method comprising: providing a drug candidate test solution comprising a drug candidate, a metal complex, and a probe, wherein the probe comprises a NMR-active nucleus; determining a relaxation rate of the NMR-active nucleus of the probe in the drug candidate test solution to provide a first relaxation rate; providing a reference solution comprising the probe and the metal complex; determining the relaxation rate of the NMR-active nucleus of the probe in the reference test solution to provide a second relaxation rate; and comparing the first and second relaxation rates to determine the effect of the drug candidate on the interaction of the probe and the metal complex, thereby predicting the effect of the drug candidate on the redox reaction-related activity of the metal complex.

In some embodiments, the method further comprises: providing one or more additional drug candidate solutions, wherein each of the one or more additional drug candidate solutions comprises the probe, the metal complex, and a different concentration of the drug candidate; determining a relaxation rate for the NMR-active nucleus of the probe in each of the one or more additional drug candidate test solutions, thereby providing one or more additional relaxation rates; and comparing the one or more additional relaxation rates with the first and second relaxation rates, thereby determining a predicted inhibitory concentration profile of the drug candidate against the redox-related activity of the metal complex. In some embodiments, the method comprises predicting a 50% inhibitory concentration (IC₅₀) for the drug candidate against the redox-related activity of the metal complex.

In some embodiments, the drug candidate comprises a mixture of two or more compounds, each of the two or more compounds having a potential for pharmaceutical activity.

In some embodiments, an effect of each of a plurality of different drug candidates on the redox-related activity of a metal complex is predicted, and the method further comprises: providing one or more additional drug candidate solutions, wherein each of the one or more additional drug candidate solutions comprises the probe, the metal complex, and a different drug candidate; determining a relaxation rate for the NMR-active nucleus of the probe in each of the one or more additional drug candidate test solutions, thereby providing one or more additional relaxation rates; and comparing each of the one or more additional relaxation rates with the second relaxation rate.

In some embodiments, the plurality of different drug candidates comprises a molecular library. In some embodiments, predicting the effect of each of the plurality of different drug candidates screens the molecular library for the presence of one or more compounds that mediate the generation of ROS in a subject.

In some embodiments, the method further comprises correlating the presence or absence of structural features in each of the plurality of different drug candidates with the predicted effect of each of the plurality of the different drug candidates on the activity of the metal complex, thereby determining structure activity relationship (SAR) data for the plurality of different drug candidates. In some embodiments, the method further comprises determining an IC₅₀ for each of the plurality of different drug candidates against the redox-related activity of the metal complex, and correlating the IC₅₀ for each of the plurality of different drug candidates with the presence or absence of structural features in each of the plurality of different drug candidates, thereby developing quantitative structure activity relationship (QSAR) data for the plurality of different drug candidates.

In some embodiments, the metal complex comprises a ligand selected from the group consisting of a protein, a peptide, a carbohydrate, a nucleic acid, a lipid, a low molecular weight natural product, or a combination or a chemically-modified derivative thereof. In some embodiments, the metal complex comprises a paramagnetic metal ion.

In some embodiments, the method further comprises: providing a second drug candidate test solution, the second drug candidate test solution comprising the probe, the drug candidate, and the metal ion of the metal complex, or a salt thereof; determining the relaxation rate of the NMR-active nucleus of the probe in the second drug candidate test solution, thereby providing a third relaxation rate; providing a second reference solution, the second reference solution comprising the probe and the metal ion of the metal complex, or a salt thereof; determining the relaxation rate of the NMR-active nucleus of the probe in the second reference solution, thereby providing a fourth relaxation rate; and comparing the difference between the first and second relaxation rates and the difference between the third and fourth relaxation rates; thereby predicting the ability of the drug candidate for displacing the metal ion from the metal complex.

In some embodiments, the presently disclosed subject matter provides a method of assaying a sample to detect the presence of one or more chemical species having an ability to affect the generation of ROS, the method comprising: providing a test sample, said test sample comprising a probe and at least one metal complex, wherein the at least one metal complex comprises a metal ion and a chemical species associated with the metal ion, and wherein the probe comprises a NMR-active nucleus; determining a relaxation rate of the NMR-active nucleus by measuring a signal in the test sample using NMR spectroscopy; determining a reference relaxation rate of the NMR-active nucleus by measuring a signal in a reference solution, wherein said reference solution comprises the probe and wherein the metal complex is absent; comparing the relaxation rate of the NMR-active nucleus in the test sample with the reference relaxation rate to determine an effect on relaxation rate caused by the presence of the metal complex; and determining whether the effect on relaxation rate caused by the presence of the metal complex is consistent with participation of the metal complex in redox activity, thereby assaying the sample for one or more chemical species having an ability to affect the generation of ROS.

In some embodiments, determining the effect on relaxation rate caused by the presence of the metal complex determines an amount of relaxation rate enhancement caused by the presence of the metal complex.

In some embodiments, the chemical species is a biomolecule selected from the group consisting of a protein, a peptide, a carbohydrate, a nucleic acid, a lipid, a low molecular weight natural product, or a combination or a chemically-modified derivative thereof. In some embodiments, the metal ion is a paramagnetic metal ion.

In some embodiments, the test sample is a biological sample selected from the group consisting of a cell extract, a tissue extract, or a biological fluid. In some embodiments, providing the test sample further comprises: providing a precursor sample comprising one or more different chemical species; adding a metal ion or a salt thereof to the precursor sample to form one or more different metal complexes, wherein each of the one or more different metal complexes comprises a metal ion and one of the one or more different chemical species; and adding a probe to the precursor sample.

In some embodiments, the precursor sample comprises a biological sample selected from the group consisting of a cell extract, a tissue extract, or a biological fluid. In some embodiments, the precursor sample comprises a plurality of different chemical species and adding a metal ion to the precursor forms a plurality of different metal complexes.

In some embodiments, providing the test sample further comprises: providing a precursor sample mixture comprising a plurality of different chemical species and at least one metal complex; separating the precursor sample mixture to provide a purified precursor sample, wherein the purified precursor sample comprises one metal complex; and adding a probe comprising a NMR-active nucleus to the purified precursor sample. In some embodiments, the separating comprises employing liquid chromatography.

In some embodiments, the precursor sample mixture comprises a plurality of metal complexes, each of the plurality of metal complexes comprising a metal ion and a different chemical species associated therewith; wherein separating the precursor sample mixture provides a plurality of purified precursor samples; and wherein a probe is added to each of the plurality of purified precursor samples to provide a plurality of test samples. In some embodiments, a relaxation rate is determined for the NMR-active nucleus present in each of the plurality of test samples and compared to the reference relaxation rate, thereby detecting the presence of one or more chemical species having an ability to affect the generation of ROS in each of the plurality of test samples.

In some embodiments, assaying the test sample for one or more chemical species having an ability to affect the generation of ROS further determines that the test sample comprises one or more chemical species or one or more metal complexes that are associated with a disease state. In some embodiments, the ability to affect the generation of ROS is the ability to prevent the generation of ROS. In some embodiments, assaying the test sample for one or more chemical species having an ability to affect the generation of ROS further determines that the sample comprises one or more chemical species or one or more metal complexes that can be used in treating a disease associated with generation of ROS. In some embodiments, the disease associated with generation of ROS is selected from the group consisting of cancer, an inflammatory disease, a neurological disease, and an infection.

In some embodiments, the presently disclosed subject matter provides a method of estimating a redox-related activity of a metal species using NMR spectroscopy, the method comprising: providing a test solution comprising a metal-reactive probe comprising a NMR-active nucleus, a non-metal-reactive internal reference species comprising an NMR-active nucleus, and a metal species; providing an NMR spectrum by subjecting the test solution to a predetermined pulse sequence; analyzing the NMR spectrum by comparing one or more resonance integrals of one or more resonance signals related to the probe with one or more resonance integrals of one or more resonance signals related to the internal reference species, thereby determining a ratio of resonance intensities of the probe and reference species; and analyzing the ratio of resonance intensities to determine whether preferential relaxation occurs for the NMR-active nucleus of the probe as a result of an interaction between the probe and the metal species.

In some embodiments, the predetermined pulse sequence comprises an initial 90 degree pulse sequence followed by a series of 180 degree refocusing pulses. In some embodiments, the method further comprises comparing the ratio of resonance intensities to one or more ratio(s) of resonance intensities determined by analyzing an NMR spectrum of one or more of a series of calibration solutions, each of said one or more calibration solutions comprising a metal species having a known redox activity, a probe, and an internal reference species.

In some embodiments, the presently disclosed subject mater provides a method of detecting a catalytic redox activity of a metal complex, the method comprising: providing a test solution comprising a probe and a metal complex in a non-steady state initial condition, wherein the non-steady state initial condition is selected from the group consisting of fully oxidized, fully reduced, and partially reduced or oxidized, and wherein the probe comprises a NMR-active nucleus; determining a relaxation rate of the NMR-active nucleus in the test solution; treating the test solution with a redox reaction substrate to provide a treated test solution; determining a relaxation rate of the NMR-active nucleus in the treated test solution; and comparing the relaxation rate of the nucleus in the test solution and the relaxation rate of the nucleus in the treated test solution. In some embodiments, the redox reaction substrate is selected from the group consisting of superoxide, hydrogen peroxide, and a mixture thereof.

In some embodiments, the presently disclosed subject matter provides a method of determining the ability of a compound to inhibit a metal-catalyzed redox reaction, the method comprising: providing one or more test samples, each of the one or more test samples comprising a metal complex and a probe comprising a NMR-active nucleus; incubating each of the one or more test samples with one or more potential inhibitory compounds; providing a first reference sample, wherein the first reference sample comprises the metal complex and the probe; treating the first reference sample and each of the one or more test samples with one or more redox reaction substrates; allowing the first reference sample and each of the one or more test samples to achieve a steady state condition with regard to the oxidation state of the metal complex; determining a relaxation rate of the NMR-active nucleus in each of the one or more test samples and in the first reference sample; and comparing the relaxation rates to determine the effects of the one or more potential inhibitory compounds on the oxidation state of the metal complex.

In some embodiments, the method further comprises providing a second reference sample, wherein the second reference sample comprises the metal complex and the probe; determining a relaxation rate of a NMR-active nucleus of the probe in the second reference sample to determine the relaxation rate of the NMR-active nucleus in the absence of one or more potential inhibitory compounds and in the absence of one or more redox reaction substrates; and comparing the relaxation rate of the NMR-active nucleus in the second reference sample with the relaxation rate of the NMR-active nucleus in each of the one or more test samples and with the relaxation rate of the NMR-active nucleus in the first reference sample. In some embodiments, the method further comprises quantifying the effects of the one or more potential inhibitory compounds on the oxidation state of the metal complex. In some embodiments, the method comprises providing a plurality of test solutions and incubating each of the test solutions with one or more different potential inhibitory compounds, thereby screening one or more different potential inhibitory compounds for inhibitory activity.

In some embodiments, the presently disclosed subject matter provides a method of detecting whether a compound inhibits metal complex catalyzed redox activity via metal atom sequestration, the method comprising: providing a test sample comprising a metal complex; contacting the test sample with an inhibitory compound in an amount effective to completely inhibit the redox activity of the metal complex; adding a probe to the test sample, wherein the probe comprises a NMR-active nucleus; determining a relaxation rate of the NMR-active nucleus in the test sample using NMR spectroscopy; treating the test sample with a metal salt for a period of time, thereby providing a regenerated test sample; determining the relaxation rate of the NMR-active nucleus in the regenerated test sample; and analyzing whether the relaxation rate of the NMR-active nucleus in the regenerated test sample indicates restoration of redox activity of the metal complex; thereby determining if the inhibitory compound inhibits the metal complex via metal atom sequestration.

In some embodiments, the method further comprises dialyzing the test sample against a dialysis solution wherein the inhibitory compound is absent to remove excess inhibitory compound prior to determining the relaxation rate of the NMR-active nucleus in the test sample. In some embodiments, the method further comprises removing excess metal salt from the regenerated test sample prior to determining the relaxation rate of the NMR-active nucleus in the regenerated test sample.

In some embodiments, the presently disclosed subject matter provides a method of measuring a metal reduction potential, the method comprising: providing a test solution comprising a metal complex, a probe comprising a NMR-active nucleus, and one or more buffer compounds, wherein the one or more buffer compounds are effective for maintaining or altering pH and electrochemical potentials within one or more pre-determined parameters; measuring an electrochemical potential of the test solution; determining a relaxation rate of the NMR-active nucleus in the test solution; treating the test solution to alter the electrochemical potential, thereby providing an altered test solution; measuring an electrochemical potential of the altered test solution; determining a relaxation rate of the NMR-active nucleus in the altered test solution; and correlating changes in relaxation rate with electrochemical potential.

In some embodiments, the method further comprises repeating the last four steps until an electrochemical potential and a relaxation rate of the NMR-active nucleus in an altered test solution corresponding to each of a plurality of electrochemical potentials within a desired testing range have been measured, determined and correlated. In some embodiments, measuring the electrochemical potential of the test solution or of the altered test solution is performed by measuring a spectrum of a redox active dye molecule present in the test solution or altered test solution. In some embodiments, treating the test solution comprises adding one or more chemical oxidants or chemical reductants.

In some embodiments, the presently disclosed subject matter provides a method of screening a plurality of compounds to detect one or more compounds that inhibits the redox activity of a metal complex by shifting a metal complex reduction potential, the method comprising: providing one or more reference solutions, each of the one or more reference solutions comprising a metal complex, a probe comprising a NMR-active nucleus, and one or more buffer components for controlling pH and electrochemical potentials within one or more pre-determined parameters; providing a plurality of test solutions, each of the plurality of test solutions comprising a metal complex, a probe comprising a NMR-active nucleus, and one or more buffer components for controlling pH and electrochemical potentials within one or more pre-determined ranges; adding one or more of the plurality of compounds to each of the plurality of test solutions; establishing a desired electrochemical potential in each of the plurality of test solutions, wherein the desired electrochemical potential approximates a reduction potential of the metal complex; determining a relaxation rate of the NMR-active nucleus in at least one of the one or more reference solutions and in each of the plurality of test solutions; and comparing the relaxation rates of the NMR-active nucleus in each of the plurality of test solutions to the relaxation rate of the NMR-active nucleus in the at least one of the one or more reference solutions to determine whether one or more of the plurality of compounds causes a shift in the relaxation of an NMR-active nucleus consistent with a change in an oxidation state equilibrium in the solution. In some embodiments, the metal complex comprises an enzyme.

In some embodiments, establishing the desired electrochemical potential comprises bulk electrolysis or the addition of an oxidizing or reducing agent. In some embodiments, at least two reference solutions are provided, and the at least two reference solutions are held at different electrochemical potentials. In some embodiments, one of the at least two reference solutions is held at the electrochemical potential of an oxidized state of the metal complex and another of the at least two reference solutions is held at the electrochemical potential of a reduced state of the metal complex.

Accordingly, it is an object of the presently disclosed subject matter to provide methods of predicting the redox-related activity of metal complexes and methods of screening compounds for their ability to mediate that activity.

An object of the presently disclosed subject matter having been stated hereinabove, which is addressed in whole or in part by the presently disclosed subject matter, other objects and aspects will become evident as the description proceeds when taken in connection with the accompanying Examples as best described herein below.

### BRIEF DESCRIPTION OF THE DRAWINGS

FIG. 1 is a schematic illustration showing the structural formulas of the metal chelating agents ethylenediamine-N,N,N′,N′-tetraacetic acid (H₄EDTA), propylenediamine-N,N,N′,N′-tetraacetic acid (H₄PDTA), ethylenediamine-N,N′-diacetic acid-N,N′-dipropionic acid (H₄β-EDDADP), diethylenetriamine-N,N,N′,N″,N″-pentaacetic acid (H₅DTPA), triethylenetetraamine-N,N,N′,N″,N′″,N′″-hexaacetic acid (H₆TTHA), and diethyl dithiocarbamate (DDC).

FIG. 2 is a graph correlating the rates of fluoride/metal complex association (k_{app,F}_{^{−}}) with rates of superoxide/metal complex reactions (k_{app,O2}_{^{−}}).

FIG. 3 is a graph showing the effects of copper (Cu)/zinc (Zn) superoxide dismutase (SOD) concentration on the relaxation rates of the ¹⁹F resonances of fluoride (shaded diamonds) and trifluoroacetate anions (open squares).

FIG. 4A is a one-dimensional nuclear magnetic resonance (NMR) spectrum of a solution comprising trifluoroacetate (tfa) and fluoride anion (F⁻). The spectrum was acquired with a single transient using a Carr-Purcell-Meiboom-Gill (CPMG) pulse sequence with 100 microsecond (ms) delay.

FIG. 4B is a one-dimensional nuclear magnetic resonance (NMR) spectrum of the solution described for FIG. 4A further comprising superoxide dismutase (SOD). The spectrum was acquired with a single transient using a Carr-Purcell-Meiboom-Gill (CPMG) pulse sequence with 100 microsecond (ms) delay.

FIG. 5 is a graph showing the effects of copper (Cu)/zinc (Zn) superoxide dismutase (SOD) concentration on the ratio of trifluoroacetate (tfa) to fluoride (F) resonance integrals in nuclear magnetic resonance (NMR) spectra.

FIG. 6 is a graph showing the effect of temperature on nuclear magnetic resonance (NMR) relaxation enhancement of trifluoroacetate anion (tfa; solid diamonds) and fluoride (open triangles) ¹⁹F resonances by iron (III) diethylenetriaminepentaacetate (Fe^{III}DTPA²⁻). Dashed lines (a) and (b) represent the predicted outer-sphere and inner-sphere contributions to relaxation rate, respectively.

FIG. 7A is a graph showing that superoxide dismutase (SOD) inhibition by 0.25 (open circles), 0.5 (shaded triangles), 1.0 (open squares), or 2.0 mM (shaded circles) concentrations of diethyl dithiocarbamate (DDC) obeys pseudo-first order kinetics.

FIG. 7B is a graph showing that pseudo-first order rater constants calculated for superoxide dismutase (SOD) are proportional to the concentration of diethyl dithiocarbamate (DDC).

FIG. 8 is a graph showing the effect of pH on the fluoride anion (F⁻)/iron (III) ethylenediamine-N,N,N″,N″-tetraacetic acid hydrate (Fe^{III}EDTA(H₂O)⁻) association rate.

FIG. 9 is a graph showing the predicted effect of superoxide generating reactants on the nuclear magnetic resonance activity of copper (Cu)/zinc (Zn) superoxide dismutase (SOD). The line marked by (a) shows the predicted activity in the absence of inhibitors (previously reported by Rigo et al., FEBS Letters, 1981, 132, 78-81). The line marked by (b) shows the predicted effect in the presence of reduction inhibiting compounds. The line marked by (c) shows the predicted effect in the presence of oxidation inhibiting compounds.

### DETAILED DESCRIPTION

The presently disclosed subject matter will now be described more fully hereinafter with reference to the accompanying Examples, in which representative embodiments are shown. The presently disclosed subject matter can, however, be embodied in different forms and should not be construed as limited to the embodiments set forth herein. Rather, these embodiments are provided so that this disclosure will be thorough and complete, and will fully convey the scope of the embodiments to those skilled in the art.

Unless otherwise defined, all technical and scientific terms used herein have the same meaning as commonly understood by one of ordinary skill in the art to which this presently described subject matter belongs. All publications, patent applications, patents, and other references mentioned herein are incorporated by reference in their entirety.

Throughout the specification and claims, a given chemical formula or name shall encompass all optical and stereoisomers, as well as racemic mixtures where such isomers and mixtures exist.

### I. DEFINITIONS

Following long-standing patent law convention, the terms “a” and “an” mean “one or more” when used in this application, including the claims. Thus, “metal complex” or “nucleus” can refer to a plurality (i.e., two or more) of metal complexes or nuclei.

A “probe” refers to any NMR active molecule or species that has a relatively long magnetic relaxation time in the absence of a paramagnetic species, but that relaxes to its ground state upon forming an inner-sphere complex with a paramagnetic metal ion. A non-limiting example is the fluoride ion, which is found in approximately 100% naturally abundant ¹⁹F isotope. The coherence of the probe's nuclear spin magnetization in the x-y plane of the spectrometer is considered an excited state, which can be relaxed (resulting in loss of spin coherence) by formation of metal/fluoride complexes. NMR probes are ions or molecules that are highly sensitive to inner-sphere contact with paramagnetic ions. NMR active nuclei of these species undergo transverse (T₂) or longitudinal (T₁) relaxation when they come into inner-sphere contact with suitable paramagnetic metal ions. U.S. Pat. No. 7,037,660 to Summers et al. describes NMR techniques involving the use of probes that have magnetic relaxation properties that are affected by the presence of paramagnetic metal ions. Probes include, but are not limited to, the fluoride anion (F⁻) and species that contain X—H bonds, where X is a non-hydrogen NMR-active nucleus. As described in U.S. Pat. No. 7,037,660, for probes containing X—H bonds, the T₂ relaxation time of the X nucleus can be monitored using ¹H detection and isotope editing.

By “species” or “chemical species” is meant a molecule, atom, radical, ion, or metal ion. Desirable species include, but are not limited to molecular libraries, inorganic molecules, synthetic molecules, natural products, antibiotics, drugs, drug candidates, derivatives of natural products, proteins, peptides, and fragments of proteins.

Nuclear magnetic resonance (NMR) spectroscopy is a technique that is widely used to study chemical and structural properties of species. The ability to detect magnetic relaxation rates, e.g., from T₁ and T₂ relaxations, provides a route to probe the environment of a particular nucleus.

By “biomolecule” is meant a substituted or unsubstituted protein, peptide, carbohydrate, lipid, nucleic acid, or low molecular weight (i.e., less than 500 Daltons) natural product.

The terms “NMR-active nuclei” and “NMR-active nucleus” is meant a nucleus or nuclei having a non-zero magnetic spin. Examples of NMR-active nuclei include, but are not limited to, ¹H, ¹³C, ³¹P, ¹⁵N, ¹⁷O, and ¹⁹F.

The term “paramagnetic metal ion” refers to a metal ion that has unpaired elections, and, therefore, has a magnetic moment. Redox active copper(II) and iron(III) ions (as well as a number of other metal ions) are paramagnetic metal ions. Interactions of these ions (and other ions as well) with certain probes can lead to relaxation of the excited states of these probes.

The term “reactive oxygen species” refers to chemical species including, but not limited to, superoxide, hydroxyl radicals, and reactive metal oxide species. Reactive oxygen species (ROS) are characterized by their ability to abstract electrons (or electron equivalents) from substrates such as DNA, thiol species, and unsaturated hydrocarbons, among others.

The term “metal complex” is a molecular or ionic species comprised of a metal ion bound by a ligand or set of ligands. The complex is held together by interactions of electron pairs on the ligand(s) with the metal ion. In some embodiments, these interactions are coordination bonds.

The term “ligand” refers to a chemical species (i.e., an ion or molecule) having one or more electron pairs that can form a bond (e.g., a coordination bond) with a metal ion. A chelating ligand is one that binds by more than one atom using more than one electron pair.

As used herein, the term “inner-sphere complex” refers to a complex having a chemical bond between an electron pair donor and a metal ion.

A reaction with an “inner-sphere mechanism” is one that proceeds along a reaction pathway that includes formation of an inner-sphere complex between a metal ion and one of the reacting partners. A reaction that has does not require formation of such an inner-sphere complex is called an “outer-sphere reaction.”

A “metal/biomolecule complex” is a metal complex where at least one electron pair is donated by an atom that is part of a biomolecule. Examples of biomolecules that bind metal ions include carbohydrates, such as low molecular weight hyaluronic acid, or chemically-modified proteins, such as those with carboxymethyl-modified lysine residues. Modified biomolecules can be prepared by chemical or enzymatic modification. Biomolecule ligands or metal/biomolecule complexes can be purified and characterized prior to analysis by one of the presently disclosed methods. In one embodiment, samples of biological origin can be treated in such a way as to promote the binding of iron(II), which would subsequently be oxidized to give the corresponding iron(III) complex.

A “drug candidate” refers to a compound or a mixture of compounds that have potential pharmaceutical activity (i.e. are suspected of having pharmaceutical activity). Thus a “drug candidate” can comprise a single compound that can be tested for a desired pharmaceutical activity. A “drug candidate” can also refer to a drug candidate mixture comprising two, three, four, or more compounds suspected of having pharmaceutical activity, either individually or in combination. A drug candidate (or drug candidate mixture) can further comprise one or more non-pharmaceutically active components, such as solubilizing agents, pharmaceutically-acceptable carriers, salts, buffer components, stabilizers, and the like.

### II. GENERAL CONSIDERATIONS

Iron catalyzes the Haber Weiss reaction (also known as the Fenton reaction) between hydrogen peroxide and superoxide to produce ROS (formulated as OH.) via the cycle outlined in Equations 1 and 2:

Fe^{III}L+O₂.⁻→Fe^{II}L+O₂ (1)

Fe^{II}L+H₂O₂→Fe^{III}L+OH⁻+OH. (2)

Most iron complexes do not catalyze production of ROS. Searching for active iron or other metal complex catalysts requires methods for either measuring or predicting the catalytic activities of metal/biomolecule complexes. Practical applications of direct activity assays are limited by the reactivities of the superoxide anion (O₂.⁻) and other derived species. Likewise, ROS analyses are typically complicated by their reactivities.

Understanding the mechanism by which metals catalyze these reactions can be of use in developing methods to identify species that contribute to ROS production in biological systems. Results of modeling studies using low molecular weight iron complexes indicate that complexes which do not catalyze Fenton chemistry are those that are not reduced by superoxide. An example of a complex that does not effectively catalyze this chemistry is the iron(III) complex of diethyletriamine-N,N,N′,N″,N″-pentaacetic acid (DTPA). While Fe^{II}DTPA reacts rapidly with hydrogen peroxide to give ROS as described by Equation 2 (see Rahhal and Richter, J. Am. Chem. Soc., 1988, 110, 3126-3133), reduction of Fe^{III}DTPA is too slow to compete with the non-catalyzed dismutation of superoxide. See Graf et al., J. Biol. Chem., 1984, 259, 3620-3624; and Egan et al., J. Inorg. Biochem., 1992, 48, 241-249).

Previous reports have proposed that these reactions proceed via outer-sphere mechanisms. This interpretation can be traced to a kinetic study of the reaction of superoxide anion with Fe^{III}EDTA(H₂O)⁻. See Bull et al., J. Am. Chem. Soc., 1983, 105, 5290-5300. An outer-sphere mechanism was proposed for the reaction, because the rate of the superoxide/Fe^{III}EDTA(H₂O)⁻ reaction was believed to be too fast to proceed by an inner-sphere mechanism. According to this model, the maximum value of the apparent second order rate constant for an inner-sphere reaction (kₘₐₓ) is the product of the rate constant for solvent exchange at the metal complex (kₛ) and the equilibrium constant for outer-sphere association of the anion with the metal complex (K_{OS}), as shown in Equation 3:

kₘₐₓ=kₛk_{OS} (3)

See Bull et al., J. Am. Chem. Soc., 1983, 105, 5290-5300.

The tentative assignment of an outer-sphere mechanism for the Fe^{III}EDTA(H₂O)⁻/O₂.⁻ reaction, however, was made using a measured value of kₛ (see Bloch and Navon, J. Inorg. Nucl. Chem., 1980, 42, 693) that has recently been shown to be low by a factor of approximately 100. See Schneppensieper et al., Inorg. Chem., 2001, 40, 3670. Using the more recent value of kₛ and a value for K_{OS} from an electrostatic model (See Bull et al., J. Am. Chem. Soc., 1983, 105, 5290-5300), Equation 3 gives a value of kₘₐₓ that is ten fold larger than the measured rate constant for the O₂.⁻/Fe^{III}EDTA(H₂O)⁻ reaction. Thus, the rate of the reaction with superoxide is similar to the rate at which Fe^{III}EDTA(H₂O)⁻ coordinates the sulfite dianion. See Dellert-Ritter and van Eldik, J. Chem. Soc., Dalton, 1992, 1037-1044. In addition, while reactivity patterns for reactions of certain synthetic metalloporphyrins with superoxide have been interpreted as supporting an outer-sphere mechanism (see Batinic-Haberle et al., Inorg. Chem., 1999, 38, 4011-4022), the patterns are not inconsistent with the inner-sphere mechanism. Support for the outer-sphere mechanism is further eroded by the inability of the Marcus cross relation to explain differences in the rates at which metal complexes are reduced by O₂.⁻. According to Marcus theory, second order rate constants for outer-sphere reactions are determined by a number of variables, including the self exchange rate constants (k₁₁) for the reacting redox partners. While the value of k₁₁ for the O₂.⁻/O₂ self exchange should be independent of which complex is used in its calculation, values calculated from data for reactions with Fe^{III}EDTA(H₂O)⁻ and Fe^{III}(CN)₆³⁻ differ by eleven orders of magnitude. See Zahir et al., J. Am. Chem. Soc., 1988, 110, 5059). Thus, the best available data do not discount the possibility that reduction of Fe^{III}EDTA(H₂O)⁻ by O₂.⁻ occurs via an inner-sphere mechanism.

### III. METHODS OF PREDICTING REDOX-RELATED ACTIVITY OF METAL COMPLEXES

If the rate of metal ion (e.g., iron (III)) reduction by superoxide is limited by the rate of ligand substitution, then the reduction rates for a given metal complex should correlate with association rates for any small anionic ligand. A number of experimental difficulties, however, can arise in measuring rates at which anions associate with the types of complexes likely to catalyze ROS generation. For example, anion coordination to complexes of interest are likely to occur rapidly with equilibrium constants that favor the reactants over products. Materials of interest can give heterogeneous mixtures with reactions occurring at solid/solution interfaces. Also, the reactions typically result in relatively small changes in the absorbance spectra of solutions. Because of these potential experimental difficulties, anation rates (i.e., rates of displacement of a ligand from a metal complex by an anion) have not been the focus of wide attention. See Richens, Chem. Rev., 2005, 105, 1961-2002).

In some embodiments, the presently disclosed methods relate to the determination of the rate at which an anionic probe containing an NMR-active nucleus enters the inner coordination sphere of a metal complex. For example, the rates at which fluoride ion enters the inner coordination sphere of iron(III) and manganese(II) complexes can be determined with relative ease using ¹⁹F NMR. Thus, in some embodiments, the transverse NMR relaxation enhancements of the ¹⁹F resonance of fluoride anion by paramagnetic metal complexes provide data on the dynamics of fluoride association, i.e., the forward reaction in Equation 4:

Fe^{III}L+F⁻⇄Fe^{III}LF (4)

Therefore, according to the presently disclosed methods, in some embodiments, simple one-dimensional NMR methods can be used to predict the in vivo oxidative toxicity of iron (or other metal ion) complexes of biological chelating ligands. In some embodiments, these methods comprise determining the transverse relaxation rate of the metal complex.

Accordingly, the presently disclosed subject matter relates to methods for detecting and characterizing the accessibility of paramagnetic metal ions to molecular species in solution. The utility of the presently disclosed methods is based on data, presented herein below, that such accessibility correlates to the generation of reduced metal complexes that, in turn, can react to form reactive oxygen species in biological systems. This data contradicts previous interpretations of earlier results which assume that metal catalyzed redox reactions do not require inner-sphere coordination. See Zahir et al., J. Am. Chem. Soc., 1988, 110, 5059; and Bull et al., J. Am. Chem. Soc., 1983, 105, 5290-5300.

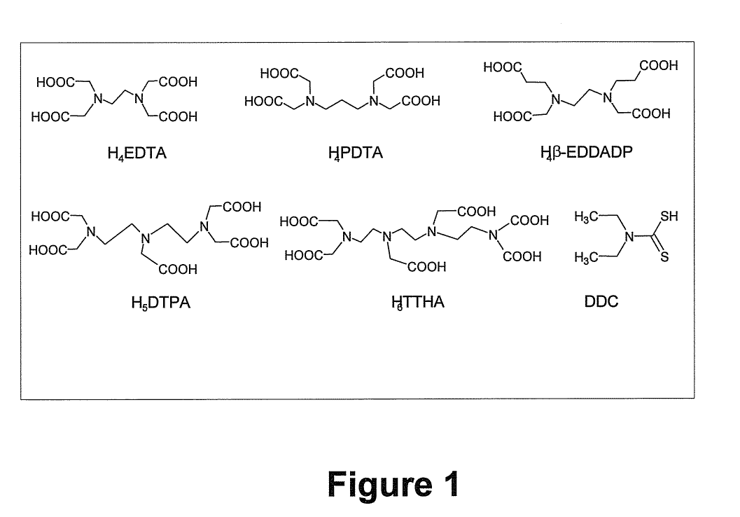

More particularly, as described further in the examples hereinbelow, the effects of eleven paramagnetic metal complexes, Fe^{III}EDTA(H₂O)⁻, Fe^{III}EDTA(OH)²⁻, Fe^{III}PDTA⁻, Fe^{III}DTPA²⁻, Fe^{III}₂O(TTHA)²⁻, Fe^{III}(CN)₆³⁻, Mn^{II}EDTA(H₂O)²⁻, Mn^{II}βPDTA²⁻, Mn^{II}β-EDDADP²⁻, Mn^{II}PO₄⁻, and the enzyme Cu/Zn SOD on F⁻ ion ¹⁹F NMR transverse relaxation rates (R₂=1/T₂) were studied in aqueous solutions as a function of temperature. See also, Summers et al., J. Am. Chem. Soc., 2008, 130, 1727-1734; and Viglino et al., J. Magn. Res., 1979, 34, 265. The structures of the low molecular weight chelating ligands from this study are illustrated in FIG. 1.

Consistent with efficient relaxation requiring formation of a metal/F⁻ bond, only the substitution inert complexes Fe^{III}(CN)₆³⁻ and Fe^{III}EDTA(OH)²⁻ had no measured effect on T₂ relaxation of the F^{- 19}F resonance. For the remaining nine complexes, kinetic parameters (apparent second order rate constants and activation enthalpies) for metal/F⁻ association were determined from the dependence of the observed relaxation enhancements on complex concentration and temperature. Apparent metal/F⁻ association rate constants for these complexes (k_{app,F}_{^{−}}) spanned six orders of magnitude.

In addition, the rates at which O₂.⁻ reacts with Fe^{III}PDTA⁻, Mn^{II}EDTA(H₂O)²⁻, Mn^{II}PDTA²⁻, and Mn^{II}β-EDDADP²⁻ were determined by pulse radiolysis. While Fe^{III}PDTA⁻ is directly reduced by O₂.⁻ to the corresponding Fe²⁺ complex, each of the Mn²⁺ complexes reacted with formation of an intermediate complex, presumably having a Mn²⁺—O₂. bond. The data for the SOD enzyme was previously reported. See Viglino et al., J. Magn. Res., 1979, 34, 265. These reactivity patterns are consistent with literature precedents for similar complexes.

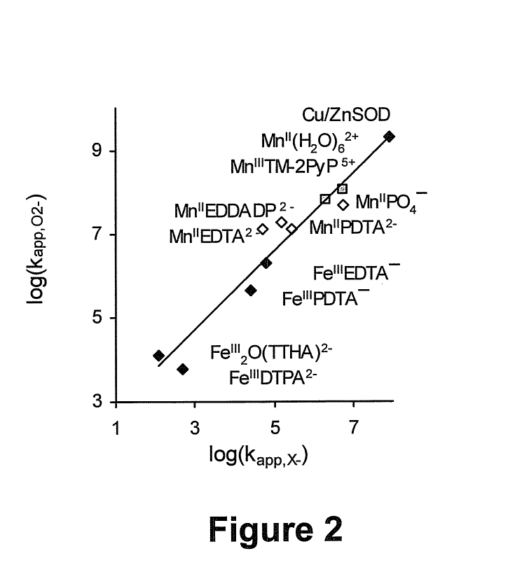

A plot of log(k_{app,O2}_{^{−}}) versus log(k_{app,F}_{^{−}}) for the nine active complexes shows a linear correlation with a slope approximately 1. See FIG. 2. This linear correlation indicates that rapid metal/O₂.⁻ reactions of these complexes occur via an inner-sphere mechanism where formation of an intermediate coordination complex limits the overall rate. This indication is also supported by the very low rates at which the substitution inert complexes (Fe^{III}(CN)₆³⁻ and Fe^{III}EDTA(OH)²⁻) are reduced by O₂.⁻. These results indicate that F^{- 19}F NMR relaxation can be used to predict the reactivities of other metal complexes toward reduction by O₂.⁻, a key step in the biological production of reactive oxygen species.

III.A NMR Methods of Predicting the Redox Activity of Metal Complexes

In some embodiments, the presently disclosed subject matter provides a method of predicting a redox reaction-related activity of a metal complex, the method comprising: providing a first test solution comprising a metal complex and a probe, wherein the probe comprises a NMR-active nucleus; and measuring a signal in the first test solution using NMR spectroscopy to determine a relaxation rate of the NMR-active nucleus, wherein said relaxation rate of the NMR-active nucleus corresponds to the accessibility of a metal atom in the metal complex to the test solution, thereby predicting the redox reaction-related activity of the metal complex. Generally speaking, metal complexes that increase the rate at which probe nuclei undergo NMR relaxation are the complexes that are most likely to catalyze redox reactions, including redox reactions with biological substrates. In some embodiments, the relaxation rate is a transverse relaxation rate.

In some embodiments, the effect of changes in concentration of the metal complex are assessed by: further providing one or more additional test solutions, wherein each of the one or more additional test solutions comprises the probe and a different concentration of the metal complex (i.e., a different concentration than in the first test solution); measuring a signal related to the probe in each of the one or more additional test solutions using NMR spectroscopy, thereby determining a relaxation rate for the NMR-active nuclei in each of the one or more additional test solutions; and comparing the relaxation rate measured for the NMR-active nucleus in the first test solution with the relaxation rate for the NMR-active nucleus in each of the one or more additional test solutions, thereby determining a sensitivity of the probe to a change in concentration of the metal complex.

Any suitable probe can be used, so long as the probe comprises a NMR-active nucleus (or nuclei) having a relatively long magnetic relaxation time in the absence of a paramagnetic species, but that relaxes to its ground state upon forming an inner-sphere complex with a paramagnetic metal ion. Ideally, the probe should be selected so that there is no spectral overlap between resonance from the probe and any resonances from other species present in test solutions. The NMR active-nucleus can be, for example, but is not limited to, ¹H, ¹³C, ³¹P, ¹⁵N, ¹⁷O, and ¹⁹F. In some embodiments, the probe is fluoride anion (i.e., F⁻). In some embodiments, the probe comprises phosphorus. For instance, a probe comprising phosphorus can comprise at least one P—H moiety and at least one terminal P—O moiety. Examples of probes comprising phosphorous include, but are not limited to, alkyl phosphate anions (e.g., methylphosphite (MeOPH) and ethylphosphite) and phosphonite anions (e.g., ethylphosphonite).

In some embodiments, the metal complex comprises a ligand selected from the group including, but not limited to, a protein, a peptide, a carbohydrate, a nucleic acid, a lipid, a low molecular weight (<500 Daltons) natural product, or a combination or a chemically-modified derivative thereof. By chemically-modified derivative is meant a ligand that has been synthetically altered from a natural form by, for example, acylation, phosphorylation, esterification, alkylation, PEGylation (attachment of a polyethylene glycol moiety), or halogenation. Chemically modified also refers to fragments of or truncated ligands (i.e., peptides or nucleic acids that partial sequences of a naturally found form). Chemically modified proteins and peptides include those comprising carboxymethyl-modified lysine residues. Chemically modified can also refer to nucleic acid or peptide analogs that contain modified nucleotide or amino acid linkages designed to increase chemical stability. In some embodiments, the metal complex comprises an enzyme.

In some embodiments, the metal complex comprises a paramagnetic metal ion. In some embodiments, the metal ion is paramagnetic in only one oxidation state of the metal ion.

In some embodiments, predicting the redox reaction-related activity of the metal complex predicts the ability of metal complex to catalyze the generation of or to prevent the generation of ROS in a biologically relevant environment. Thus, in some embodiments, the ability of the metal complex to catalyze the generation of or to prevent the generation of ROS in one of a cell, a tissue, a biological fluid or a subject can be predicted. The cell can be a eukaryotic cell. The subject can be a mammalian subject. The tissue (e.g., brain, lung, heart, muscle, liver, kidney, pancreatic, skin, or nerve tissue) can be present in a living mammalian subject or ex vivo (i.e., not present in a living subject). The biological fluid can be, but is not limited to, a cell or tissue extract, blood, plasma, saliva, or any other fluid comprising materials (cells or cell components) taken from a subject.

In some embodiments, the cell, tissue, biological fluid or subject is associated with a disease state. By “associated with a disease state” is meant that a disease state, or a symptom thereof, is present in the cell, tissue, biological fluid or subject, or that the cell, tissue, biological fluid, or subject is at risk of developing the disease or is at risk of a recurrence of the disease. For example, the cell, tissue, biological fluid or subject can comprise a particular enzyme or other protein or a particular nucleic acid or other species typically present in the disease state. Alternatively, the cell, tissue, biological fluid or subject can comprise an abnormal level of a particular enzyme, protein, nucleic acid, or other species, wherein the abnormal level of said enzyme, protein, nucleic acid, or other species is believed to be the cause or result of the disease state. In some embodiments, the disease state is related to cancer, an inflammatory disease (e.g., RA, atherosclerosis, inflammatory bowel disease, etc.), a neurological disease (e.g., ALS or Parkinson's disease), or an infection (e.g., a bacterial, fungal, protozoal, or viral infection).

In some embodiments, a plurality of different test solutions are provided, each of the plurality of different test solutions comprising a different metal complex and a probe comprising a NMR-active nucleus. The redox reaction-related activity of each different metal complex can be predicted by measuring a signal in each test solution using NMR spectroscopy to determine a relaxation rate of the NMR-active nucleus. The relaxation rates can be compared from the different test solutions to predict which of the different metal complexes are likely to have greater or lesser redox reaction-related activity than any of the other different metal complexes. By different metal complex is meant that the either the metal ion or the ligand (or one of the ligands) or both is not the same as the metal ion or a ligand in another one of the metal complexes being studied.

III.B. NMR Methods of Estimating Redox-Related Activity Employing an Internal Reference Species

In some embodiments, the presently disclosed subject matter provides a method of estimating a redox-related activity of a metal species using NMR spectroscopy, the method comprising: providing a test solution comprising a metal-reactive probe comprising a NMR-active nucleus, a non-metal-reactive internal reference species comprising an NMR-active nucleus, and a metal species; providing an NMR spectrum by subjecting the test solution to a predetermined pulse sequence; analyzing the NMR spectrum by comparing one or more resonance integrals of one or more resonance signals related to the probe with one or more resonance integrals of one or more resonance signals related to the internal reference species, thereby determining a ratio of resonance intensities of the probe and reference species; and analyzing the ratio of resonance intensities to determine whether preferential relaxation occurs for the NMR-active nucleus of the probe as a result of an interaction between the probe and the metal species.

The predetermined pulse sequence can be based on the CPMG method. Thus, in some embodiments, the predetermined pulse sequence comprises an initial 90 degree pulse sequence followed by a series of 180 degree refocusing pulses. A low field NMR instrument can be used. By “low field NMR” is meant an instrument operating at a magnetic field strength such as to give a ¹⁹F precession frequency of about 56 MHz (or a ¹H frequency of about 60 MHz) or less.

In some embodiments, analyzing the ratio of resonance intensities can involve comparing the resonance intensities to those determined for metal complexes having known redox-related activity. Thus, in some embodiments, the method can further comprise comparing the ratio of resonance intensities to one or more ratio(s) of resonance intensities determined by analyzing an NMR spectrum of one or more of a series of calibration solutions, each of said one or more calibration solutions comprising a metal species having a known redox activity, a probe, and an internal reference species.

In some embodiments, the probe can be fluoride anion, a phosphorus containing species such as methylphosphite, or any other charged or neutral species containing NMR active nuclei that interact strongly with paramagnetic metal ions. The internal reference species can be trifluoroacetate (tfa), tetramethyl phosphonium ion, or any other charged or neutral species containing NMR active nuclei that do not interact strongly with paramagnetic metal ions.

III.C. NMR Methods of Detecting Catalytic Redox Activity of Metal Complexes

In some embodiments, the presently disclosed subject matter provides a method of detecting catalytic redox activity from steady state data. The method relies on there being a difference in the relaxation enhancement behavior of the metal complex in its oxidized and reduced states. For example, the enzyme Cu/Zn SOD can catalyze dismutation of superoxide into oxygen and hydrogen peroxide. During catalysis, the copper ion at the active site of the enzyme cycles between an oxidized and reduced state. In the oxidized state, the metal ion is paramagentic and can affect the NMR relaxivity of NMR-active nuclei. However, in the reduced state, the metal ion is dimagnetic and has no affect on NMR relaxivity. See Rigo et al., FEBS Lett., 1981, 132, 78-81.

In some embodiments, the catalytic redox activity of a metal complex can be determined by measuring a NMR relaxation rate of a probe in the presence of a metal complex and comparing that relaxation rate to the NMR relaxation rate of the probe in the presence of the metal complex and a redox reaction substrate. For example, in some embodiments, the presently disclosed subject matter provides a method of detecting a catalytic redox activity of a metal complex, the method comprising: providing a test solution comprising a probe and a metal complex in a non-steady state initial condition, wherein the non-steady state initial condition is selected from the group consisting of fully oxidized, fully reduced, and partially reduced or oxidized, and wherein the probe comprises a NMR-active nucleus; determining a relaxation rate of the NMR-active nucleus in the test solution; treating the test solution with a redox reaction substrate to provide a treated test solution; determining a relaxation rate of the NMR-active nucleus in the treated test solution; and comparing the relaxation rate of the nucleus in the test solution and the relaxation rate of the nucleus in the treated test solution.

Any convenient redox reaction substrate can be used. By “redox reaction substrate” is meant a chemical species which can undergo a reduction or oxidation reaction. In some embodiments, the redox reaction substrate is related to a biologically relevant redox reaction. Thus, the redox reaction substrate can be, but is not limited to, the group including, but not limited to, superoxide, hydrogen peroxide, and a mixture thereof. Superoxide can be generated by either enzymatic reactions (such as xanthine/xanthine oxidase) or by chemical methods (such as NADH/phenazine methosulfate (PMS)). See, e.g., Ewing and Janero, Anal. Biochem., 1995, 232, 243-248; and Rao, Free Radic. Biol. Med., 1989, 7, 513-519.

### IV. METHODS OF PREDICTING THE EFFECTS OF COMPOUNDS ON THE REDOX-RELATED ACTIVITY OF METAL COMPLEXES

IV.A. Methods of Identifying Drug Candidates Affecting the Redox-Related Activity of Metal Complexes

In addition to identifying likely redox-active metal complexes, the presently disclosed subject matter also provides methods that can be used in drug discovery to target these species with therapeutics that prevent or enhance their activities. Thus, in some embodiments, the presently disclosed subject matter further provides methods of testing a drug candidate or for screening a series of drug candidates for their capability to mitigate the redox-related catalytic effects of metal complexes (e.g., metal/biomolecule complexes).

Potential drug candidates can mitigate the catalytic effects of metal/biomolecule complexes by a number of possible methods. For example, drug candidates could act by: (1) binding to the biomolecule ligand to displace metal ions from the complex; (2) binding to the biomolecule/metal complex in ways that prevent contact between the metal and an exogenous species (e.g., superoxide); (3) binding in a way that prevents redox cycling of the complex; or (4) shifting the electrochemical reduction potential of the metal to one that is disfavorable for catalysis. In some embodiments, the methods can be used to determine the relative or absolute affinities of species (e.g., drug candidates) for metal/biomolecule complexes. The most promising drug candidates for blocking ROS production are typically those that bind specifically and with high affinity to the metal complex in such a way as to give maximum inhibition of the effects of the complex on relaxation rates of probe nuclei.

In some embodiments, the presently disclosed subject matter provides a method of predicting an effect of a drug candidate on the redox reaction-related activity of a metal complex, the method comprising: providing a drug candidate test solution comprising a drug candidate, a metal complex, and a probe,

wherein the probe comprises a NMR-active nucleus; determining a relaxation rate of the NMR-active nucleus of the probe in the drug candidate test solution to provide a first relaxation rate; providing a reference solution comprising the probe and the metal complex; determining the relaxation rate of the NMR-active nucleus of the probe in the reference test solution to provide a second relaxation rate; and comparing the first and second relaxation rates to determine the effect of the drug candidate on the interaction of the probe and the metal complex, thereby predicting the effect of the drug candidate on the redox reaction-related activity of the metal complex. In some embodiments, the relaxation rate is a transverse relaxation rate. In some embodiments, the relaxation rate is determined using a CPMG pulse sequence.

In some embodiments, the method further comprises providing one or more additional drug candidate solutions, wherein each of the one or more additional drug candidate solutions comprises the probe, the metal complex, and a different concentration of the drug candidate; determining a relaxation rate for the NMR-active nucleus of the probe in each of the one or more additional drug candidate test solutions, thereby providing one or more additional relaxation rates; and comparing the one or more additional relaxation rates with the first and second relaxation rates, thereby determining a predicted inhibitory concentration profile of the drug candidate against the redox-related activity of the metal complex. If desired, a 50% inhibitory concentration (IC₅₀) for the drug candidate against the redox-related activity of the metal complex can be determined.

Any suitable probe can be used, so long as the probe comprises a NMR-active nucleus (or nuclei) having a relatively long magnetic relaxation time in the absence of a paramagnetic species, but that relaxes to its ground state upon forming an inner-sphere complex with a paramagnetic metal ion. Ideally, the probe is selected so that there is no spectral overlap between resonance from the probe and any resonances from other species present in test solutions. The NMR active-nucleus can be, for example, but is not limited to, ¹H, ¹³C, ³¹P, ¹⁵N, ¹⁷O, and ¹⁹F. In some embodiments, the probe is fluoride anion (i.e., F⁻). In some embodiments, the probe comprises phosphorus. For instance, a probe comprising phosphorus can comprise at least one P—H moiety and at least one terminal P—O moiety. Examples of probes comprising phosphorous thus, include, but are not limited to alkyl phosphate anions (e.g., methylphosphite (MeOPH) and ethylphosphite) and phosphonite anions (e.g., ethylphosphonite).

Suitable drug candidates can comprise any compound known to have or believed to have the potential for pharmaceutical activity. Drug candidates can include, but are not limited to, low molecular weight natural products, biomolecules (e.g., proteins, peptides, nucleic acids, lipids, carbohydrates), or chemically-modified derivatives thereof. In addition to the compound or compounds having or suspected of having pharmaceutical activity, the drug candidate (or the test solution) can further comprise non-pharmaceutically active components, such as those generally used in the pharmaceutical industry to solubilize or stabilize pharmaceutically active compounds.

In some embodiments, the drug candidate can comprise a mixture of two or more compounds, each of the two or more compounds having a potential for pharmaceutical activity. The two or more drug candidate compounds can be present in equal or in unequal amounts. Each of the two or more drug candidates can have the potential for pharmaceutical activity separately, or they can be known to or be suspected of working together to produce an effect. In some embodiments, the two or more compounds can be known to or be suspected of working synergistically to produce a pharmaceutical effect.

In some embodiments, the effect of more than one drug candidate can be predicted. For example, in some embodiments, an effect of each of a plurality of different drug candidates on the redox-related activity of a metal complex is predicted, the method further comprising: providing one or more additional drug candidate solutions, wherein each of the one or more additional drug candidate solutions comprises the probe, the metal complex, and a different drug candidate; determining a relaxation rate for the NMR-active nucleus of the probe in each of the one or more additional drug candidate test solutions, thereby providing one or more additional relaxation rates; and comparing each of the one or more additional relaxation rates with the second relaxation rate.

In some embodiments, the plurality of different drug candidates comprises a molecular library. The molecular library can be a commercially available small molecule or natural product library. The molecular library can also be a library specifically synthesized or otherwise assembled for screening according to the presently disclosed method. In some embodiments, the molecular library can be screened for the presence of one or more compounds that mediate the generation of ROS in a subject or other biologically relevant environment. Thus, in some embodiments, one or more compounds within the library will be identified as having the potential to mediate (catalyze the generation of or inhibit the generation on ROS. In some embodiments, screening can determine that none of the compounds present in the library would be predicted to mediate ROS.

The activity predicted by the presently disclosed methods can be compared and/or correlated to other characteristics of the drug candidate. These characteristics can include, but are not limited to, size, chemical functional groups present, shape, polarity, basicity, flexibility, other know pharmacological activity, and the like. In some embodiments, the method can further comprise correlating the presence or absence of structural features in each of the plurality of different drug candidates with the predicted effect of each of the plurality of the different drug candidates on the activity of the metal complex, thereby determining structure activity relationship (SAR) data for the plurality of different drug candidates. In some embodiments, the predicted effect of a plurality of different drug candidates on the activity of the metal complex can be quantified and compared with structural features of the different drug candidates to determine quantitative structure activity relationship (QSAR) data. Thus, in some embodiments, the method further comprises determining an IC₅₀ for each of the plurality of different drug candidates against the redox-related activity of the metal complex, and correlating the IC₅₀ for each of the plurality of different drug candidates with the presence or absence of structural features in each of the plurality of different drug candidates.

In some embodiments, the metal complex comprises a ligand selected from the group including, but not limited to, a protein, a peptide, a carbohydrate, a nucleic acid, a lipid, a low molecular weight (<500 Daltons) natural product, or a combination or a chemically-modified derivative thereof. By chemically-modified derivative is meant a ligand that has been synthetically altered from a natural form by, for example, acylation, phosphorylation, esterification, alkylation, PEGylation (attachment of a polyethylene glycol moiety), or halogenation. Chemically modified also refers to truncated ligands (i.e., peptides or nucleic acids that partial sequences of a naturally found form). Chemically modified can also refer to nucleic acid or peptide analogs that contain modified nucleotide or amino acid linkages designed to increase chemical stability. In some embodiments, the metal complex comprises an enzyme (e.g., SOD, or another enzyme having antioxidant activity).

In some embodiments, the metal complex comprises a paramagnetic metal ion. In some embodiments, the metal ion is paramagnetic in only one oxidation state of the metal ion.

As described hereinabove, in some embodiments, the effect of the drug candidate on the redox reaction-related activity is based on the ability of the drug candidate to displace the metal ion from the metal complex. Thus, in some embodiments, the method of predicting the effect of a drug candidate on the redox reaction-related activity of the metal complex further comprises: providing a second drug candidate test solution, the second drug candidate test solution comprising the probe, the drug candidate, and the metal ion of the metal complex, or a salt thereof; determining the relaxation rate of the NMR-active nucleus of the probe in the second drug candidate test solution, thereby providing a third relaxation rate; providing a second reference solution, the second reference solution comprising the probe and the metal ion of the metal complex, or a salt thereof; determining the relaxation rate of the NMR-active nucleus of the probe in the second reference solution, thereby providing a fourth relaxation rate; and comparing the difference between the first and second relaxation rates and the difference between the third and fourth relaxation rates. If the drug candidate displaces the metal ion from the metal complex, the difference between the first and second relaxation rates and the difference between the third and fourth relaxation rates should be similar.

IV.B. Methods of Detecting Inhibitors of Metal Complex Redox Activity

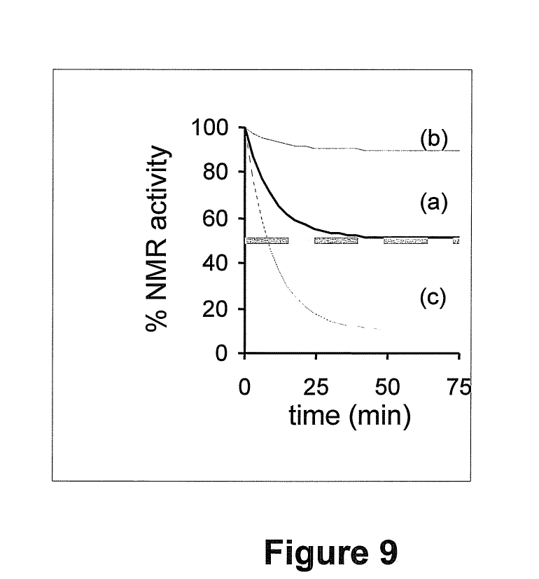

In some embodiments, compounds can be screened specifically for their ability to inhibit the redox-related activity of a metal complex. Thus, in some embodiments, the presently disclosed subject matter provides a method of determining the ability of a compound to inhibit a metal-catalyzed redox reaction, the method comprising: providing one or more test samples, each of the one or more test samples comprising a metal complex and a probe comprising a NMR-active nucleus; incubating each of the one or more test samples with one or more potential inhibitory compounds; providing a first reference sample, wherein the first reference sample comprises the metal complex and the probe; treating the first reference sample and each of the one or more test samples with one or more redox reaction substrates; allowing the first reference sample and each of the one or more test samples to achieve a steady state condition with regard to the oxidation state of the metal complex; determining a relaxation rate of the NMR-active nucleus in each of the one or more test samples and in the first reference sample; and comparing the relaxation rates to determine the effects of the one or more potential inhibitory compounds on the oxidation state of the metal complex. As described in FIG. 9 and Example 13, a compound that inhibits the redox activity of the metal complex can affect the position of the steady state equilibrium, and addition of the redox reaction substrate(s) can give rise to a different behavior than that observed in the absence of the inhibitor.

In some embodiments, the method further comprises providing a second reference sample, wherein the second reference sample comprises the metal complex and the probe; determining a relaxation rate of a NMR-active nucleus of the probe in the second reference sample to determine the relaxation rate of the NMR-active nucleus in the absence of one or more potential inhibitory compounds and in the absence of one or more redox reaction substrates; and comparing the relaxation rate of the NMR-active nucleus in the second reference sample with the relaxation rate of the NMR-active nucleus in each of the one or more test samples and with the relaxation rate of the NMR-active nucleus in the first reference sample.

In some embodiments, the effects of the one or more potential inhibitory compounds on the oxidation state of the metal complex can be quantified. For example, the effect of different concentrations of one of the one or more potential inhibitory compounds can be assayed and compared to provide an inhibitory concentration profile for that compound. In some embodiments, the effect of one or more of the potential inhibitory compounds can be compared with the effect of a known inhibitor of the metal complex's redox activity.

Potential inhibitory compounds can be selected from the same group as the compounds described hereinabove for drug candidates. In some embodiments, the potential inhibitory compound is selected from the group including, but not limited to, a protein, a peptide, a carbohydrate, a nucleic acid, a lipid, a low molecular weight (<500 Daltons) natural product, or a combination or a chemically-modified derivative thereof.

The effects of more than one potential inhibitory compound can be assayed and compared. Thus, in some embodiments, the method comprises providing a plurality of test solutions and incubating each of the test solutions with one or more different potential inhibitory compounds, thereby screening one or more different potential inhibitory compounds for inhibitory activity. In some embodiments, the one or more different potential inhibitory compounds can comprise a molecular library.

As described hereinabove, one way in which compounds can interact with metal complexes that can affect the redox-related activity of the metal complex is by preventing contact of the metal with other species. For example, the compound can interact with the metal complex so that the metal cannot interact with one or more substrate of a redox reaction. This type of interaction by a compound can be referred to as metal atom (or metal ion) sequestration.

In some embodiments, the presently disclosed subject matter can detect whether a compounds inhibits metal complex catalyzed redox activity via metal atom sequestration, the method comprising: providing a test sample comprising a metal complex; contacting the test sample with an inhibitory compound in an amount effective to completely inhibit the redox activity of the metal complex; adding a probe to the test sample, wherein the probe comprises a NMR-active nucleus; determining a relaxation rate of the NMR-active nucleus in the test sample using NMR spectroscopy; treating the test sample with a metal salt for a period of time, thereby providing a regenerated test sample; determining the relaxation rate of the NMR-active nucleus in the regenerated test sample; and analyzing whether the relaxation rate of the NMR-active nucleus in the regenerated test sample indicates restoration of redox activity of the metal complex; thereby determining if the inhibitory compound inhibits the metal complex via metal atom sequestration. By “completely inhibit” refers to the amount of compound effective to inhibit 100% or essentially all of the predicted redox-related activity of the metal complex.

In some embodiments, the exact concentration of inhibitory compound needed to inhibit 100% of the redox-related activity of the metal complex is unknown or is not known with a suitable level of accuracy. Thus, in some embodiments, it can be desirable to contact the test sample with an amount of the inhibitory compound believed to be in excess to that needed to fully inhibit metal complex activity. In some embodiments, it can be desirable to ensure the removal of any excess inhibitory compound (i.e., inhibitory compound present in the test sample, but not inhibiting the activity of (or interacting with) the metal complex). For example, excess inhibitory compound can increase the amount of metal salt needed to provide the regenerated test sample. Thus, in some embodiments, the method can further comprise dialyzing the test sample against a dialysis solution wherein the inhibitory compound is absent to remove excess inhibitory compound prior to determining the relaxation rate of the NMR-active nucleus in the test sample. As would be understood by one of skill in the art, the dialysis solution is selected to be one in which the inhibitory compound has good solubility, but if possible, in which the metal complex does not have good solubility.

Similarly, the exact amount of metal salt needed to provide the regenerated test sample can be unknown or known only with a certain degree of accuracy. In order to ensure that the all of the originally present metal complex is regenerated, it can be desirable to provide an excess amount of metal salt. However, the presence of excess metal salt can affect the accuracy of the relaxation rate measured in the regenerated test sample. Thus, in some embodiments, the method can further comprise removing excess metal salt from the regenerated test sample prior to determining the relaxation rate of the NMR-active nucleus in the regenerated test sample.

### V. ASSAYING THE ABILITY OF CHEMICAL SPECIES TO AFFECT THE GENERATION OF ROS

The presently disclosed methods can be used to identify and characterize chemical species (including biomolecule species) that bind iron or other metals in such a way as to catalyze or inhibit a variety of redox reactions. Some of these reactions have been linked to oxidative stress and disease. Thus, the methods of the presently disclosed subject matter can be used to identify chemical species that could be targeted by therapeutics so that their ability to bind metal ions is reduced, thereby reducing levels of metal complexes having redox-related activity and/or the ability to catalyze the generation of ROS in a subject, if desired.

Alternatively, in some embodiments, the presently disclosed subject matter can be used to design therapeutic metal complexes by identifying chemical species that bind to metal ions to provide redox-active metal catalysts. Such drugs could affect biological activities by interfering with signaling molecules, such as nitric oxide (NO) or S-nitrosothiols, or by catalyzing production of ROS themselves. Another alternative is for a drug to act by catalyzing thiol oxidation thereby altering intracellular thiol/disulfide ratios.

Therefore, in some embodiments, the presently disclosed subject matter provides a method of assaying a sample to detect the presence of one or more chemical species having an ability to affect the generation of ROS, the method comprising: providing a test sample, said test sample comprising a probe and at least one metal complex, wherein the at least one metal complex comprises a metal ion and a chemical species associated with the metal ion, and wherein the probe comprises a NMR-active nucleus; determining a relaxation rate of the NMR-active nucleus by measuring a signal in the test sample using NMR spectroscopy; determining a reference relaxation rate of the NMR-active nucleus by measuring a signal in a reference solution, wherein said reference solution comprises the probe and wherein the metal complex is absent; comparing the relaxation rate of the NMR-active nucleus in the test sample with the reference relaxation rate to determine an effect on relaxation rate caused by the presence of the metal complex; and determining whether the effect on relaxation rate caused by the presence of the metal complex is consistent with participation of the metal complex in redox activity, thereby assaying the sample for one or more chemical species having an ability to affect the generation of ROS. By “affecting the generation of ROS” is meant an ability to catalyze or enhance the generation of ROS to any extent or to inhibit (completely or to a certain extent) the generation of ROS.

In some embodiments, determining the effect on relaxation rate caused by the presence of the metal complex determines an amount of relaxation rate enhancement caused by the presence of the metal complex. Determining the amount of relaxation rate enhancement can be done by one-dimensional NMR studies, for example, using a CPMG technique. The relaxation rate can be R₂, the transverse magnetic relaxation rate.

The chemical species can be any molecule, atom, radical, or ion. In some embodiments, the chemical species is selected from the group including, but not limited to, a member of a molecular library, an inorganic molecule, a synthetic molecule, a natural product, an antibiotic, a known drug, a drug candidate, a derivative of a natural product, a protein, a peptide, a nucleic acid, a lipid, a carbohydrate, and a fragment of a protein or nucleic acid. In some embodiments, the chemical species is a biomolecule selected from the group including, but not limited to, a protein, a peptide, a carbohydrate, a nucleic acid, a lipid, a low molecular weight natural product (<500 Daltons), or a combination or a chemically-modified derivative thereof. By chemically-modified derivative is meant a biomolecule that has been synthetically altered from a natural form by, for example, acylation, phosphorylation, esterification, alkylation, PEGylation (attachment of a polyethylene glycol moiety), or halogenation. Chemically modified can also refers to fragmented or truncated biomolecules (i.e., peptides or nucleic acids that partial sequences of a naturally found form). Chemically modified can refer to peptides and proteins comprising carboxymethyl-modified lysine residues. Chemically modified can also refer to nucleic acid or peptide analogs that contain modified nucleotide or amino acid linkages designed to increase chemical stability. In some embodiments, the chemical species is a species that would be naturally present in a subject.

In some embodiments, the metal complex comprises a paramagnetic metal ion. In some embodiments, the metal ion can be paramagnetic in only one oxidation state of the metal ion. In some embodiments, the metal complex is an enzyme.

Any suitable probe can be used, so long as the probe comprises a NMR-active nucleus (or nuclei) having a relatively long magnetic relaxation time in the absence of a paramagnetic species, but that relaxes to its ground state upon forming an inner-sphere complex with a paramagnetic metal ion. The probe should be selected so that there is no spectral overlap between resonance from the probe and any resonances from other species present in test solutions. The NMR active-nucleus can be, for example, but is not limited to, ¹H, ¹³C, ³¹P, ¹⁵N, ¹⁷O, and ¹⁹F. In some embodiments, the probe is fluoride anion (i.e., F⁻). In some embodiments, the probe comprises phosphorus. For instance, a probe comprising phosphorus can comprise at least one P—H moiety and at least one terminal P—O moiety. Examples of probes comprising phosphorous thus, include, but are not limited to alkyl phosphate anions (e.g., methylphosphite (MeOPH) and ethylphosphite) and phosphonite anions (e.g., ethylphosphonite).

In some embodiments, the test sample is a biological sample selected from the group including, but not limited to, a cell extract, a tissue extract, or a biological fluid. In some embodiments, providing the test sample further comprises: providing a precursor sample comprising one or more different chemical species; adding a metal ion or a salt thereof to the precursor sample to form one or more different metal complexes, wherein each of the one or more different metal complexes comprises a metal ion and one of the one or more different chemical species; and adding a probe to the precursor sample. The precursor sample can comprise a biological sample selected from the group including, but not limited to, a cell extract, a tissue extract, or a biological fluid.

In some embodiments, the precursor sample comprises more than one chemical species that can form a metal complex with a metal ion. Thus, in some embodiments, the precursor sample comprises a plurality of different chemical species and adding a metal ion to the precursor sample forms a plurality of different metal complexes, each of the different metal complexes comprising the metal ion and a different chemical species. In some embodiments, a metal complex can be formed that comprises the metal ion and two or more different chemical species. In some embodiments, more than one different type of metal ion can be added to the precursor sample, and one or more chemical species in the precursor sample can form two or more different metal complexes, each of the different metal complexes comprising a different metal ion.

In some embodiments, the presently disclosed subject matter provides a method of separating and purifying chemical species found in complex mixtures, wherein the redox-related catalytic abilities of the species separated from the mixtures are determined. In some embodiments, providing the test sample further comprises: providing a precursor sample mixture comprising a plurality of different chemical species and at least one metal complex; separating the precursor sample mixture to provide a purified precursor sample, wherein the purified precursor sample comprises one metal complex; and adding a probe comprising a NMR-active nucleus to the purified precursor sample.

In some embodiments, the separating comprises employing liquid chromatography. For instance, high performance liquid chromatography (HPLC) can be employed to separate species in the precursor sample (or the test sample). Any suitable stationary and mobile phase can be used. Normal phase (i.e., a polar stationary phase and a non-polar mobile phase), reverse phase (i.e., a non-polar stationary phase and a polar mobile phase), size exclusion, or ion exchange HPLC can be used, depending upon the characteristics of the species in the sample, in order to provide separation in the most convenient time frame and/or to provide samples of an acceptable purity level. In some embodiments, HPLC can be used in conjunction with mass spectroscopy, NMR or another method of chemical characterization to identify individual chemical species and/or metal complexes following separation.

In some embodiments, the precursor sample mixture comprises a plurality of metal complexes, each of the plurality of metal complexes comprising a metal ion and a different chemical species associated therewith; wherein separating the precursor sample mixture provides a plurality of purified precursor samples; and wherein a probe is added to each of the plurality of purified precursor samples to provide a plurality of test samples. In some embodiments, a relaxation rate is determined for the NMR-active nucleus present in each of the plurality of test samples and compared to the reference relaxation rate, thereby detecting the presence of one or more chemical species having an ability to affect the generation of ROS in each of the plurality of test samples.

Assaying the test sample for one or more chemical species having an ability to affect the generation of ROS can further determine that the test sample comprises one or more chemical species or one or more metal complexes that are associated with a disease state. Thus, in some embodiments, the presently disclosed methods can be used in medical or veterinary diagnostic screening to detect the presence or likelihood of a disease state in a subject. Alternatively or additionally, the methods can be in medical research to detect chemical species that can be targeted by a therapeutic to prevent or treat a disease. In some embodiments, the ability to affect the generation of ROS is the ability to prevent the generation of ROS. In some embodiments, assaying the test sample for one or more chemical species having an ability to affect the generation of ROS further determines that the sample comprises one or more chemical species or one or more metal complexes that can be used in treating a disease associated with generation of ROS. The disease associated with generation of ROS can be cancer, an inflammatory disease, a neurological disease, or an infection.

### VI. REDUCTION POTENTIAL

Vi A. Methods of Measuring Metal Reduction Potential

In some embodiments, the presently disclosed subject matter provides a method of measuring a metal reduction potential, the method comprising: providing a test solution comprising a metal complex, a probe comprising a NMR-active nucleus, and one or more buffer compounds, wherein the one or more buffer compounds are effective for maintaining or altering pH and electrochemical potentials within one or more pre-determined parameters; measuring an electrochemical potential of the test solution; determining a relaxation rate of the NMR-active nucleus in the test solution; treating the test solution to alter the electrochemical potential, thereby providing an altered test solution; measuring an electrochemical potential of the altered test solution; determining a relaxation rate of the NMR-active nucleus in the altered test solution; and correlating changes in relaxation rate with electrochemical potential.

In some embodiments, the method further comprises repeating the steps until an electrochemical potential and a relaxation rate of the NMR-active nucleus in an altered test solution corresponding to each of a plurality of electrochemical potentials within a desired testing range have been measured, determined and correlated.

In some embodiments, measuring the electrochemical potential of the test solution or of the altered test solution is performed by measuring a spectrum of a redox active dye molecule present in the test solution or altered test solution. Suitable redox active dye molecules include any molecule that undergoes a color change at a particular electrochemical potential. Generally, the color change will be reversible and is based upon the reduction-oxidation equilibrium of the dye. The redox active dye molecule can be pH dependent or independent. Some pH dependent dyes include: acid blue 92; acid red 1, acid red 88, acid red 151, acridine orange, alizarin yellow R, alizarin red, acid violet 7, azure A, brilliant yellow, brilliant green, brilliant blue G, bromocresol green, bromocresol purple, bromocresol blue, bromothymol blue, chrysophenine, chlorophenol red, Congo red, cresol red, m-cresol purple, o-cresolphthalein complexone, o-cresolphthalein, curcumin, crystal violet, dichloroindophenol, 1,5-diphenylcarbazide, eosin bluish, erythrosine B, ethyl red, ethyl violet, fast black K-salt, indigocarmine, malachite green base, malachite green hydrochloride, malachite green oxalate, methyl green, methyl red, methyl violet, methylthymol blue, murexide, metanil yellow, methyl orange, naphtholphthalein, napthol green, neutral red, Nile blue, alpha-naphthol-benzein, pyrocatechol violet, 4-phenylazophenol, 1(2-pyridyl-azo)-2-naphthol, 4(2-pyridylazo) resorcinol, rose bengal, resazurin, quinalidine red, thymol blue, tetrabromophenol blue, thionin and xylenol orange. In some embodiments, the dye is selected from the group including, but not limited to, methylene blue, thionin, Azure A, Azure B, Azure C, methylene green, new methylene blue N, toluidine blue 0, methylene violet, toluoylene red (i.e., natural red), and safranin.

In some embodiments, treating the test solution comprises adding one or more chemical oxidants or chemical reductants. Representative common oxidants (oxidizing agents) include: ammonium persulfate; potassium permanganate; potassium dichromate; potassium chlorate and other chlorates; potassium bromate; potassium iodate; sodium hypochlorite and other chlorites; perchlorates; nitric acid; nitrous oxide; chlorine; bromine; iodine; cerium(IV) sulfate; iron(III) chloride; hydrogen peroxide; sodium peroxide and other peroxides; ozone; sulfoxides; manganese dioxide; and oxygen. Representative common reducing agents include: sodium sulfite and other sulfites; sodium arsenate; sodium thiosulfate; sulphurous acid; sodium thiosulphate; hydrogen sulfide; hydrogen iodide; stannous chloride; certain metals (e.g. zinc, ferrous(II) sulfate or any iron(II) salt, titanium(III) sulphate, tin(II) chloride); hydrazine; and oxalic acid. Treating the test solution can also comprise electrolysis.

Suitable buffering compounds include, but are not limited to, tris(hydroxymethyl)aminomethane (tris), 2-(N-morpholino)ethanesulfonic acid (MES), N,N-bis(2-hydroxyethyl)-2-aminoethanesulfonic acid (BES), piperazine-1,4-bis(2-ethanesulfonic acid) (PIPES), (4-(2-hydroxyethyl)-1-piperazineethanesulfonic acid) (HEPES), N-(2-acetamido)-2-aminoethanesulfonic acid (ACES), bicine, and the like. One or more additional chemical acids or bases can be added to the test solution to change the pH of the solution.

VI.B. Methods of Screening Compounds that Shift Metal Complex Reduction Potential

As described hereinabove, as well as in FIG. 9 and Example 13, a compound that inhibits redox behavior of the complex can affect the position of the steady state equilibrium and addition of redox reaction substrate(s) can give rise to a different behavior than observed in the absence of the inhibitor. In contrast, a compound that does not affect redox activity of the complex will not affect the position of the steady state mixture.

In some embodiments, the presently disclosed subject matter provides a method of screening a plurality of compounds to detect one or more compounds that inhibits the redox activity of a metal complex by shifting a metal complex reduction potential, the method comprising: providing one or more reference solutions, each of the one or more reference solutions comprising a metal complex, a probe comprising a NMR-active nucleus, and one or more buffer components for controlling pH and electrochemical potentials within one or more pre-determined parameters; providing a plurality of test solutions, each of the plurality of test solutions comprising a metal complex, a probe comprising a NMR-active nucleus, and one or more buffer components for controlling pH and electrochemical potentials within one or more pre-determined ranges; adding one or more of the plurality of compounds to each of the plurality of test solutions; establishing a desired electrochemical potential in each of the plurality of test solutions, wherein the desired electrochemical potential approximates a reduction potential of the metal complex; determining a relaxation rate of the NMR-active nucleus in at least one of the one or more reference solutions and in each of the plurality of test solutions; and comparing the relaxation rates of the NMR-active nucleus in each of the plurality of test solutions to the relaxation rate of the NMR-active nucleus in the at least one of the one or more reference solutions to determine whether one or more of the plurality of compounds causes a shift in the relaxation of an NMR-active nucleus consistent with a change in an oxidation state equilibrium in the solution.

In some embodiments, the metal complex comprises a biomolecule ligand. In some embodiments, the metal complex comprises an enzyme. For example, in some embodiments, the metal complex is SOD. SOD can act as an antioxidant in vivo, acting to provide a defense against the ROS superoxide.

In some embodiments, establishing the desired electrochemical potential comprises bulk electrolysis or the addition of an oxidizing or reducing agent.

In some embodiments, at least two reference solutions are provided, and the at least two reference solutions are held at different electrochemical potentials. For example, in some embodiments, one of the at least two reference solutions is held at the electrochemical potential of an oxidized state of the metal complex and another of the at least two reference solutions is held at the electrochemical potential of a reduced state of the metal complex. Thus the at least two reference solutions can be used as controls to provide the relaxation rate for the NMR-active nucleus in the presence of the fully oxidized and fully reduced metal complex.

### VII. ADVANTAGES

One benefit of the presently disclosed methods is that the methods rely on the measurement of properties related to probes, and not of properties of the ligands, themselves. Thus, high concentrations of the ligands are not required. This is particularly helpful when the ligands are biomolecule chelating ligands, which are generally present or isolatable in low concentrations.

Another benefit of the presently disclosed methods is that high concentrations of the probe species can be used. Thus, low magnetic field spectrometers can be employed in performing the presently disclosed methods.

A third benefit is that the presently disclosed methods do not rely on the generation of highly reactive molecular species, such as superoxide, hydroxyl radical, or oxidizing metal complexes, or the detection of relatively unstable chromaphores. Methods for introducing superoxide typically rely on either enzymatic reactions, or on relatively reactive chemical species. The latter require rapid mixing under alkaline conditions. Enzyme activities can degrade with time and require substrates that can react with other molecular species present in test solutions or other activity assay-related systems. There have been reports questioning the reliability of screening data based on methods that monitor reactions of superoxide ion. See Soulere et al., Bioorg. Med. Chem., 2003, 11, 4941-4944; and Huang et al., Nature, 2000, 407, 390).

A further benefit is that the presently disclosed methods are not reliant on alkaline solutions. Therefore, the testing conditions can be similar to physiological conditions.

### EXAMPLES

The following Examples have been included to provide guidance to one of ordinary skill in the art for practicing representative embodiments of the presently disclosed subject matter. In light of the present disclosure and the general level of skill in the art, those of skill can appreciate that the following Examples are intended to be exemplary only and that numerous changes, modifications, and alterations can be employed without departing from the scope of the presently disclosed subject matter.

The presently disclosed Examples refer to measuring fluoride/metal interactions and the use of NMR to characterize metal complex activity. In some of the Examples, methods are described for characterizing interactions of metal complexes with low molecular weight compounds that result in inhibition of metal redox chemistry. While some of the Examples refer to reactions of the enzyme, Cu/Zn SOD, similar experiments could be used to characterize interactions of any metal/complex, including those other biomolecules that modulate biological oxidative stress. Similarly, while some of the Examples predict the reactions of the SOD with its natural substrate, superoxide, similar experiments can be performed to predict the reactivity of any metal complex toward any redox active substrate that reacts via an inner-sphere mechanism.

### Example 1

### Effects of Metal Complexes on T₂ Relaxation Rates Measured by NMR Spectroscopy

Unless otherwise stated, transverse relaxation rates (R₂, defined as 1/T2) of fluoride anion (F⁻) used in the following examples were measured using techniques described by Carr, Purcell, Meinboom, and Gill (CPMG) using a JEOL Eclipse 300 MHz NMR spectrometer (JEOL Ltd., Tokyo, Japan). CPMG is the standard technique for measuring transverse NMR relaxation times (T₂). See, for example, Braun et al., “150 and More Basic NMR Experiments,” Wiley-VCH Weinheim, 1998, page 159.

### Example 2

### Measurement of Transverse Relaxation Enhancement Using One-Dimensional NMR

The effect of a given metal complex on a probe nucleus relaxation rate can be measured in a one-dimensional NMR experiment. As demonstrated herein, the ¹⁹F NMR relaxation rate of the fluoride resonance in a given solution can be determined from a one-dimensional spectrum if the solution contains both fluoride (F⁻) and an internal reference species (e.g., trifluoroacetate (tfa), which has the formula CF₃CO₂⁻) with a resonance that has a relaxation rate that is relatively independent of enzyme concentration.

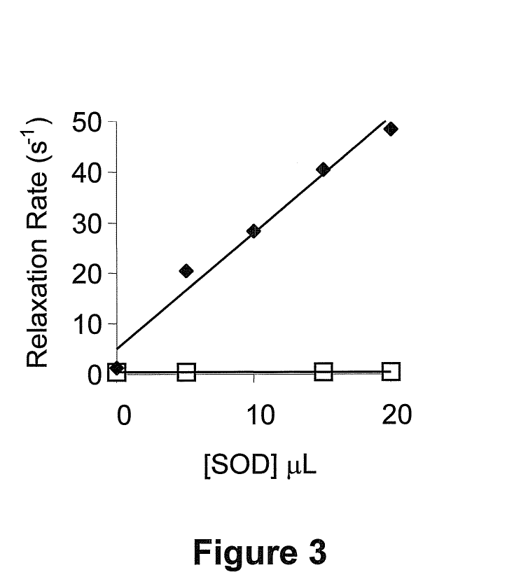

A series of solutions containing fluoride, tfa, buffer, and an enzyme (i.e., Cu/Zn SOD) were prepared. The relaxation rates of the fluoride nuclei were measured using the CPMG method. As shown in FIG. 3, the enzyme had almost no effect on the relaxation rate of tfa (as shown by the data indicated by the open squares) under the conditions of the experiment, but had a marked affect on fluoride relaxation (data indicated by the shaded diamonds).

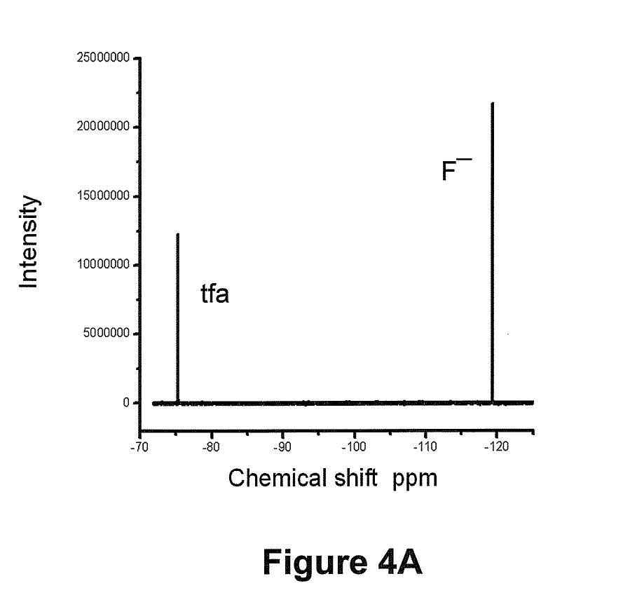

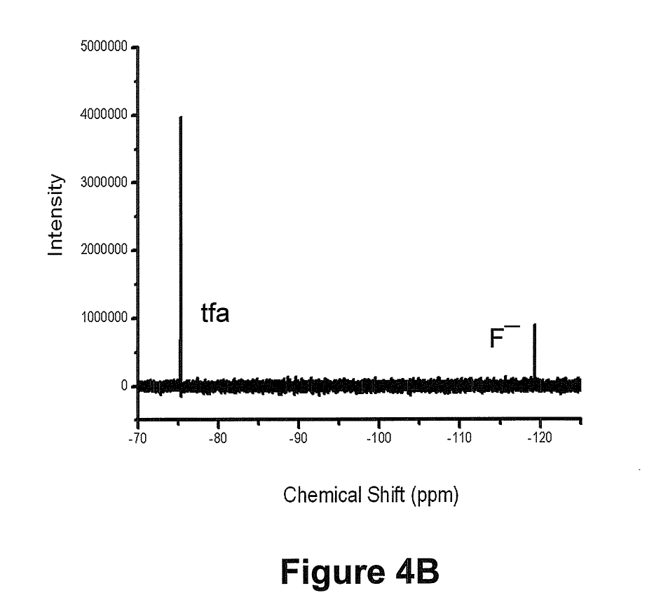

The effects of Cu/Zn SOD on the one dimensional ¹⁹F NMR spectra of solutions containing F⁻ and tfa are also illustrated in FIGS. 4A and 4B. The spectra shown in FIGS. 4A and 4B were recorded using solutions containing 20 mM NaF and 5 mM tfa at 282 MHz (using a 300 MHz ¹H frequency spectrometer) with a single transient. The spectra were collected using a conventional CPMG pulse sequence including an initial 90 degree x pulse followed by a series of 180 degree refocusing pulses. The total relaxation delay was 100 ms.

FIG. 4A shows the spectrum of a diamagnetic solution of the two anions. FIG. 4B shows the spectrum of the same solution, but following the addition of approximately 10⁻⁷ M enzyme (100 catalytic units per 600 μL sample). The effects of Cu/Zn SOD on the NMR resonances are proportional to Cu/Zn SOD concentration. Further, the effect of Cu/Zn SOD on the fluoride resonance is much more pronounced than on the tfa resonance.

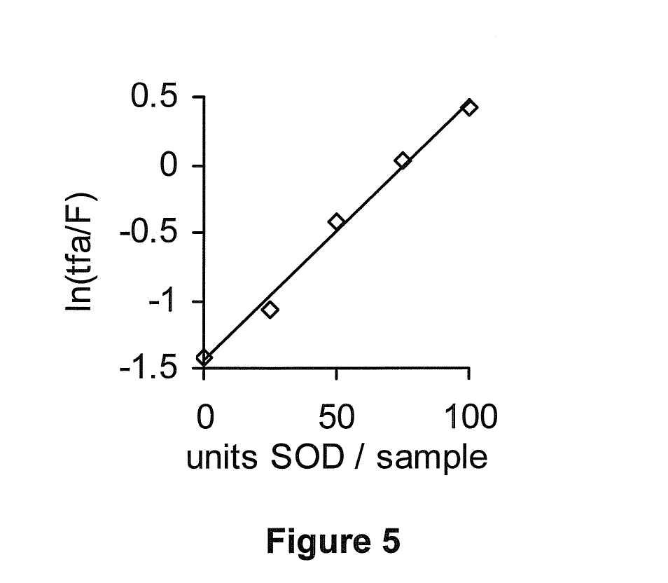

The concentration of active metal complex in a solution can be determined from the ratio of the integrated tfa and F resonances (I_{tfa}/I_{F}) at a single relaxation time, as expressed in Equation 5:

[SOD_{Active}]=C₁ ln(I_{tfa}/I_{F})+C₂ (5)

where C₁ and C₂ are constants that depend on the sensitivities of the fluoride and tfa resonances to relaxation by the enzyme, the delay, and the concentrations of fluoride and tfa. FIG. 5 shows that the ratio of the peak areas for the two resonances correlates with metal complex concentration. This result indicates that relaxation rates (and thus, SOD concentration) can be determined using one dimensional NMR experiments.

### Example 3

### ¹⁹F NMR Spectra of Fluoride Solutions at Physiological Ionic Strength Measured Using Low Field Instruments

One advantage of the presently disclosed methods arises from its ability to measure metal complex activity using low field NMR instruments. Good signal to noise can be achieved for a sample containing NaF consistent with physiological ionic strength in a single scan at low field strength. In particular, it was found that spectra with good signal to noise could be acquired on a 100 mM sample of fluoride with a single transient using a 60 MHz ¹H frequency NMR with a permanent magnet. Fluoride did not inhibit SOD under the conditions of the experiment; the association constant for fluoride binding is 1.2 M⁻¹. See Viglino et al., J. Mag. Res., 1979, 34, 265.

### Example 4

### Determination of Rate Constants for Metal Association; Reactions of Metal Complexes with a Fluoride Probe

Rate constants for metal/probe association reactions can be related directly to the effects of the metal complex on the NMR relaxation rates of probe nuclei. When relaxation enhancements obey Arrhenius temperature dependence relaxation enhancement was governed by the kinetics of metal/fluoride association as described in Equation 6:

R_{2,obs}−R_{2,dia}=k_{app,F}−[M] (6)

where R_{2,dia} is the relaxation rate in diamagnetic solution and k_{app,F}_{^{−}} is the apparent second order rate constant for metal/F⁻ association. The effects of eleven paramagnetic metal complexes, Fe^{III}EDTA(H₂O)⁻, Fe^{III}EDTA(OH)²⁻, Fe^{III}PDTA⁻, Fe^{III}DTPA²⁻, Fe^{III}₂O(TTHA)²⁻, Fe^{III}(CN)₆³⁻, Mn^{II}EDTA(H₂O)²⁻, Mn^{II}PDTA²⁻, Mn^{II}β-EDDADP²⁻, Mn^{II}PO₄⁻, and Cu/Zn SOD on F⁻ ion ¹⁹F NMR transverse relaxation rates (R₂=1/T2) were studied in aqueous solutions as a function of temperature. Transverse relaxation of the ¹⁹F NMR signal of a fluoride ion was measurably enhanced by nine of the complexes: Fe^{III}EDTA(H₂O)⁻, Fe^{III}PDTA⁻, Fe^{III}₂O(TTHA)²⁻, Fe^{III}DTPA²⁻, Mn^{II}EDTA²⁻, Mn^{II}PDTA²⁻, Mn^{II}EDDADP²⁻, Mn^{II}PO₄⁻, and Cu/Zn SOD. With the exception of Fe^{III}DTPA²⁻ (discussed hereinbelow in Example 5), relaxation enhancement by these nine reactive complexes obeyed Arrhenius behavior, indicating that relaxation is governed by kinetics. Rate constants and activation enthalpies for metal/fluoride association with these metal complexes are presented in Tables 1 and 2 for the iron(III) and manganese(II) complexes, respectively.

TABLE 1
Kinetic Parameters for Reactions of Iron(III) Complexes
with Superoxide and Fluoride in Aqueous Solution.

| | Superoxide | | |
|---|---|---|---|
| | Reaction | Flouride Association Reaction | |
| Complex | k_{app,O2-}(M⁻¹s⁻¹) | k_{app,X}−(M⁻¹s⁻¹) ^{(a)} | ΔH^{‡}(kJ/mol) |
| Fe^{III}CN₆ ³⁻ | 2.7 × 10^{2 (b)} | — | — |
| Fe^{III}DTPA²⁻ | 6 × 10^{3 (c)} | 2.4 × 10² | 22 |
| Fe^{III}₂O(TTHA)²⁻ | 1.2 × 10^{4 (d)} | 1.2 × 10¹ | 39 |
| Fe^{III}PDTA⁻ | 4.6 × 10^{5 (e)} | 2.5 × 10⁴ | 37 |
| Fe^{III}EDTA(H₂O)⁻ | 1.9 × 10^{6 (f)} | 9.3 × 10⁴ | 39 |

^{(a)} 25° C. rate constants measured in 90% H₂O/10% D₂O solution, pH 6 except where indicated.
^{(b)} From Zehavi and Rabini, J. Phys. Chem., 1972, 76, 3703.
^{(c)} From Egan et al., J. Inorg. Biochem., 1992, 48, 241-249.
^{(d)} From Rush and Cabelli, Radiat. Phys., Chem., 1997, 49, 661.
^{(e)} pH 8.3.
^{(f)} From Bull et al., J. Am. Chem. Soc., 1983, 105, 5290-5300.

TABLE 2
Kinetic Parameters For Reactions of Manganese(II) Complexes
with Superoxide and Fluoride in Aqueous Solution.

| | Superoxide Reaction Data | | Anion Binding Data | |
|---|---|---|---|---|
| | k_{app,O2,A} × 10⁻⁷ | k_{app,O2,B} × 10⁻² | k_{app,X}− | ΔH^{‡} |
| Complex | (M⁻¹s⁻¹) | (s⁻¹) | (M⁻¹s⁻¹) ^{(a)} | (kJ/mol) |
| Mn^{II}EDTA(H₂O)²⁻ | 1.24 ± 0.24 | 4.0 ± 0.8 | 6.0 × 10⁴ | 31 |
| Mn^{II}PDTA²⁻ | 1.33 ± 0.26 | 2.0 ± 0.4 | 1.9 × 10⁵ | 19 |
| Mn^{II}β-EDDADP²⁻ | 1.95 ± 0.40 | 3.5 ± 0.7 | 1.3 × 10⁵ | 22 |
| Mn^{II}PO₄ ⁻ | 5.0 × 10^{7 (b,c)} | | 1.8 × 10^{6 (b)} | 42 |
| Mn^{III}TM-2-PyP⁵⁺ | 6.2 × 10^{7 (d)} | | 2.1 × 10^{6 (e)} | 36 ^{(e)} |
| Mn^{II}(H₂O)₆²⁺ | 1.1 × 10^{8 (f)} | | 5.8 × 10^{6 (e)} | 47 ^{(e)} |

^{(a)} 25° C. rate constants measured in 90% H₂O/10% D₂O solution, pH 7 except where indicated. Except for Mn(III)TM-2-Pyp⁵⁺(see note c), data are for metal/F⁻association.
^{(b)} Measured at pH 6.
^{(c)} From Cabelli and Bielski, J. Phys. Chem., 1984, 88, 6291.
^{(d)} From Batinic-Haberle et al., Inorg. Chem., 1999, 38, 4011-4022.
^{(e)} Rate data for MeOPH⁻ association, from Summers et al., Inorg. Chem., 2001, 40, 6547.
^{(f)} From Pick-Kaplan and Rabini, J. Phys. Chem., 1976, 80, 1840.

### Example 5

### Determination of the Rate Constant for Metal Association with a Fluoride Probe Species for the case of Fe^{III}DTPA²⁻

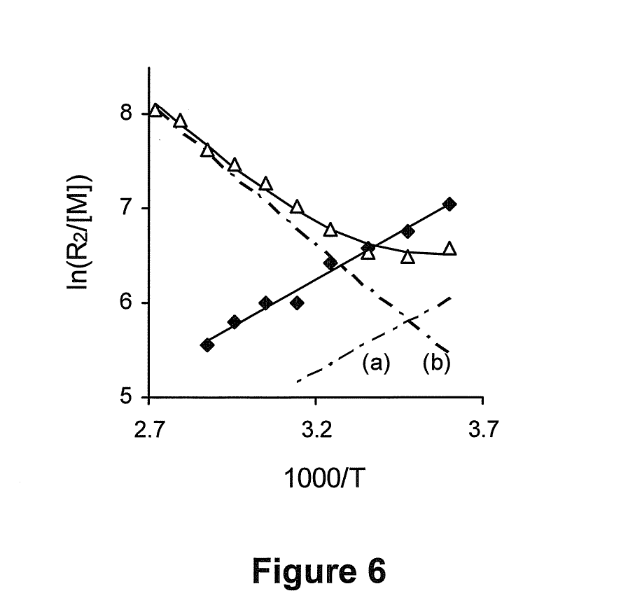

The F^{- 19}F relaxation enhancement by Fe^{III}DTPA²⁻ did not display Arrhenius temperature dependence. See FIG. 6, open triangles. Without being bound to any one theory, the curvature of the plot can arise from a similarity in the magnitudes of outer-sphere and inner-sphere contributions to relaxation (R_{2,OS} and R_{2,IS}). See Dwek, R. A., Nuclear Magnetic Resonance in Biochemistry, Clarendon, Oxford, 1973. It has been suggested that when R_{2,IS} and R_{2,OS} are of similar size, kₐₚₚ can be estimated by subtracting R_{2,OS} from R_{2,obs}. See Dwek, R. A., Nuclear Magnetic Resonance in Biochemistry, Clarendon, Oxford, 1973. To estimate the contribution of R_{2,OS}, relaxation enhancement of the ¹⁹F resonance of the trifluoroacetate anion (tfa) by Fe^{III}DTPA²⁻ was measured. R_{2,IS} for the tfa resonance should be negligible due to the low basicity of the anion and the absence of a through bond pathway for magnetic interaction between the paramagnetic center and the ¹⁹F nuclei. For the tfa resonance, R_{2,obs} decreased with increasing temperature consistent with an outer-sphere interaction. See FIG. 6, solid diamonds.

Accordingly, it was assumed that R_{2,obs} for the tfa ¹⁹F resonance equals the outer-sphere contribution to the R_{2,obs} for F⁻. Based on this assumption, R_{2,obs} for the F^{- 19}F resonances should asymptotically approach that of the tfa ¹⁹F resonance at low temperature. However, it was found that relaxation of the tfa nuclei at low temperatures (<25° C.) was more sensitive to Fe^{III}DTPA²⁻ concentration than was relaxation of the F⁻ nucleus. Without being bound to any one theory, and while this effect could arise if the lifetime of a transient tfa complex (Fe^{III}EDTA(tfa)²⁻) is greater than that of Fe^{III}EDTA(F)²⁻, this behavior is believed to be more likely due to differences in factors that determine the outer-sphere relaxation rates (outer-sphere correlation times and distance of closest approach). While R_{2,IS} should obey Arrhenius temperature dependence, where R_{2,OS} decays with temperature as described by Equation 7;

ΔR_{2,obs}/TΔ[M]=αexp(−ΔH^{‡}/RT)+βexp(γ/T) (7)

where α, β, and γ are constants. The γ term for F⁻ relaxation in Equation 7 was set equal to the slope of the least squares line for the tfa data, and ΔH^{‡}, α, and β were refined to give the curved trend line following the F⁻ data in FIG. 6. Dashed lines (a) and (b) in FIG. 6 represent the predicted outer-sphere and inner-sphere contributions to the relaxation rate, respectively. The 25° C. association rate constant and activation enthalpy in Table 1 (and used in FIG. 2) are from this refinement.

### Example 6

### Correlation of T₂ Relaxation Rates with Superoxide Reaction Rates for a Series of Metal Complexes

Rapid reactions of Fe³⁺ with superoxide (O₂.⁻) appear to occur via inner-sphere mechanisms where metal/O₂.⁻ association is rate limiting. Under this scenario, rates of metal/O₂.⁻ reactions are expected to correlate with rates at which the metal complexes coordinate F⁻. As shown in FIG. 2, a plot of log(k_{app,O2}_{^{−}}) versus log(k_{app,F}_{^{−}}) for eight reactive complexes displays a linear correlation extending six orders of magnitude. Data for FIG. 2 are provided in Tables 1 and 2.

In addition to metal/F⁻ association data, FIG. 2 includes published rate data for reactions of a water soluble manganese(III) porphyrin (Mn^{III}TM-2-PyP⁵⁺). One of the gray squares in FIG. 2 compares the rate of metal/MeOPH association to the catalytic rate constant for O₂.⁻ dissmutation (k_{cat}) for Mn^{III}TM-2-PyP⁵⁺. See Summers et al., Inorg. Chem., 2001, 40, 6547. Values of k_{cat} for manganese(III) porphyrins are thought to be limited by rates of Mn³⁺ reduction. See Batinic-Haberle et al., Inorg. Chem., 1999, 38, 4011-4022.

Thus, the fit of the gray square to the trend line in FIG. 2 suggests that the rate limiting step in the catalytic dissmutation of O₂.⁻ by Mn^{III}TM-2-PyP⁵⁺ is the inner-sphere coordination of the two reactants. The complexes that were inert toward F⁻ exchange (Fe^{III}(CN)₆³⁻ and Fe^{III}EDTA(OH)²⁻) also react slowly with O₂.⁻. These results are all consistent with rapid metal/O₂.⁻ reactions proceeding through inner-sphere mechanisms.

### Example 7

### General Procedure for Using Fluoride ¹⁹F NMR Relaxation to Monitor SOD Inhibition

A stock solution containing buffer, fluoride (20 mM), and enzyme is prepared in 10% D₂O. When the measurement is done using a one-dimensional NMR experiment, the buffer is prepared to contain approximately 2 mM tfa. The enzyme concentration is adjusted to give an observed fluoride T₂ relaxation rate of approximately 25 s⁻¹. Aliquots of the solution (588 μL) are mixed with 12 μL of inhibitor at varying concentration in DMSO, providing standardized NMR samples comprising 2% by volume DMSO. Concentrations of inhibitor compounds in the DMSO solutions are such that final NMR samples contain no more than 100 μM inhibitor. The NMR sample solutions are mixed with a vortex mixer and the T₂ NMR relaxation rate determined for the ¹⁹F resonance of the fluoride ion.

### Example 8

### Kinetics and Mechanism of DDC Inhibition of Cu/Zn SOD

The compound diethyl dithiocarbamate (DDC, structure shown in FIG. 1) inhibits Cu/Zn SOD by removing the copper from the enzyme. See Heikkila et al., J. Biol. Chem., 1976, 251, 2182). According to the presently disclosed subject matter, it has been found that SOD inhibition by DDC can be monitored using the fluoride assay. Addition of inhibitory concentrations of DDC cause the fluoride relaxation rate to revert to that measured in the absence of the enzyme. From these results, it can be concluded that ¹⁹F NMR relaxation can be used to monitor the inhibition reaction and that this process occurs on a time scale where the kinetics of inhibition can be monitored.

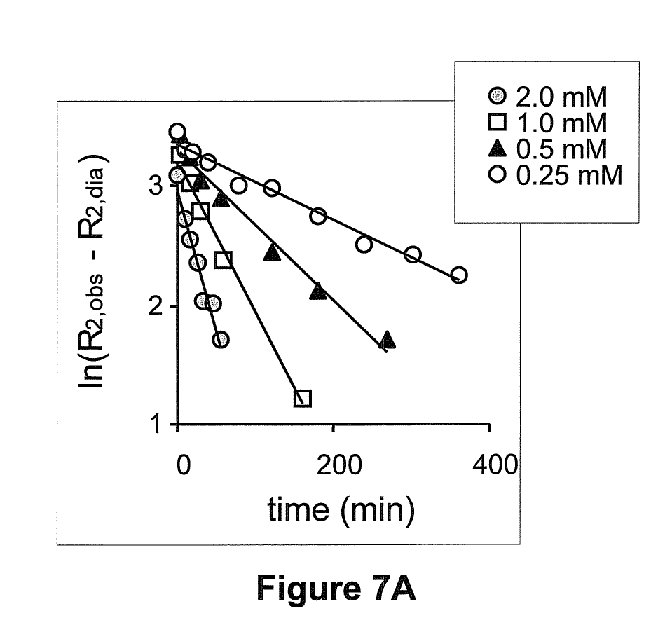

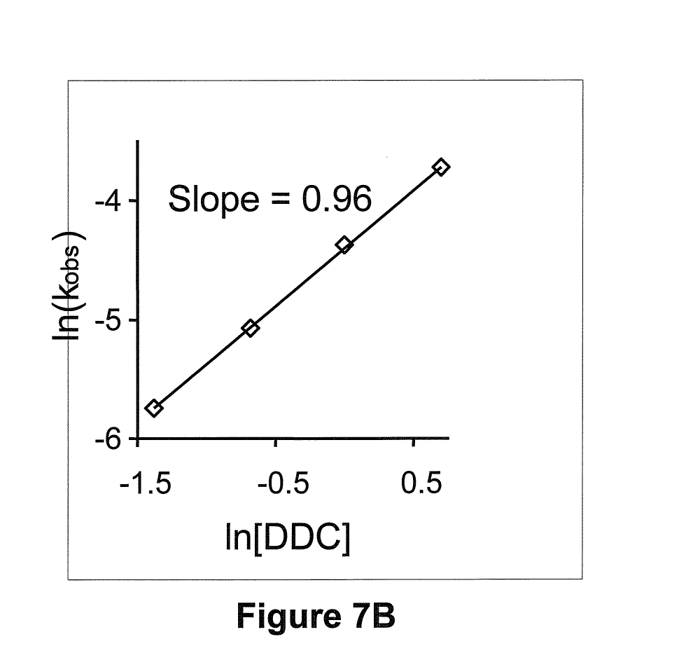

The effects of DDC (at concentrations ranging from 2.0 to 0.25 mM) on fluoride relaxation enhancement by SOD have been measured as a function of time. As shown in FIG. 7A, SOD activity decays with pseudo-first order kinetics when treated with DDC. A log/log plot of kₐₚₚ versus [DDC] has a slope of 1, indicating that inhibition is first order in DDC. See FIG. 7B. In addition to demonstrating the use of ¹⁹F methods to study metalloenzyme inhibition, the experiments provide insight into the mechanism of inhibition for the specific case. Since inhibition is first order in DDC, the rate limiting step involves reaction with a single DDC molecule.

### Example 9

### Effects of 2-Methoxyestradiol on Superoxide Dismutase Under Neutral Conditions

To determine the effect of 2-methoxyestradiol (2ME2) on the interaction of SOD with fluoride, a first sample containing fluoride in 20 mM phosphate buffered saline (pH 7.2) was prepared. SOD was added to give an NMR relaxation rate of 28 s⁻¹. A second sample was prepared from the first sample by addition of 2ME2 (in DMSO) to give a final concentration of 100 μM 2ME2 in 2% DMSO. This concentration of 2ME2 was previously reported to give complete inhibition of Cu/Zn SOD. See Huang et al., Nature, 2000, 407, 390-395. Transverse relaxation rates measured for the ¹⁹F resonances were identical for the two samples, indicating that access of solution to the metal at the active site of the enzyme was not restricted by 2ME2 under neutral conditions. It was also determined that under these conditions, reaction of the enzyme with superoxide was not inhibited.

### Example 10

### Effects of 2-Methoxyestradiol on Superoxide Dismutase in Carbonate Solution

In contrast to the behavior observed in phosphate buffer, described in Example 9, treatment of SOD with 2ME2 in carbonate solution did prevent access of fluoride ion to the active site metal. The effect of 2ME2 on Cu/Zn SOD was originally demonstrated in solution containing 50 mM sodium carbonate. See Huang et al., Nature, 2000, 407, 390-395). To repeat the conditions of this previously described study, a solution containing fluoride, tfa, and sufficient enzyme to give a fluoride relaxation rate of 23 s⁻¹ was prepared. One aliquot (488 μL) was treated with 12 μL of a 5 mM solution of 2ME2 in DMSO. After an overnight incubation, the relaxation rate of the fluoride was measured to be 3 s⁻¹. Thus, under basic conditions, treatment of Cu/Zn SOD with 100 μM 2ME2 in carbonate solution resulted in inhibition, as previously reported.

### Example 11

### Determination of Metal Complex Inhibition Using One-Dimensional NMR

Inhibitors that restrict access of the fluoride to the paramagnetic metal center at the SOD active site will diminish relaxation enhancement of the fluoride resonance. Further, IC₅₀ values can be determined from the dependence of the relaxation enhancement on the concentrations of the inhibitors.

More particularly, if a decrease in the rate of fluoride relaxation occurs due to enzyme inhibition, the % inhibition can be determined from the ratio of peak integrals, (I_{tfa}/I_{F})ᵢₙₕ, measured in the inhibited solution as described by Equation 8:

% Inhibition=(C₁C₃−C₁ ln(I_{tfa}/I_{F})ᵢₙₕ)/(C₁C₃+C₂) (8)

where C₃ is the value of ln(I_{tfa}/I_{F}) observed in the absence of an inhibitor. Thus, compounds that inhibit access of fluoride to the SOD active site will cause the ratio I_{fta}/I_{F}, to decrease relative to that observed with the uninhibited enzyme, with the minimum value being equal to the concentration ratio: [tfa]/[F⁻].

### Example 12

### Determination of the Relative or Absolute Binding Affinity of a Chemical Species to a Metal Complex: Determining the Affinity of Hydroxide Ion (OH⁻) for Fe^{III}EDTA⁻

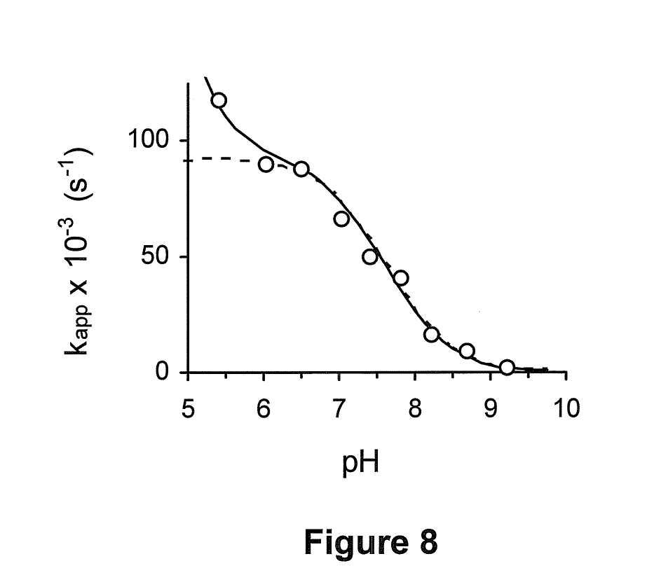

The complex Fe^{III}EDTA(H₂O)⁻ is known to react with the hydroxide anion. The resulting hydroxo complex does not react with O₂.⁻ and does not associate with SO₃²⁻. While Fe^{III}EDTA(OH)²⁻ is usually formed by deprotonation of coordinated water, its formation can also be thought of (in thermodynamic terms) as a ligand exchange. To investigate the thermodynamics of the formation of Fe^{III}EDTA(OH)²⁻, the reaction of F⁻ with Fe^{III}EDTA(H₂O)⁻ was studied as a function of pH. For Fe^{III}EDTA(H₂O)⁻, relaxation enhancements were measured for thirteen buffer conditions, having pH values ranging from 4.0 to 9.2. FIG. 8 shows the effect of pH on relaxation enhancement by Fe^{III}EDTA(H₂O)⁻. Data at pH 4.0, 4.3, and 4.7 conformed to the solid trend line, but were omitted for clarity. In this pH range, F^{- 19}F relaxation enhancement is governed by two protic equilibria, hydrolysis of Fe^{III}EDTA(H₂O)⁻ and protonation of F⁻, as described by Equations 9 and 10:

Fe^{III}EDTA(H₂O)⁻+OH⁻⇄Fe^{III}EDTA(OH)²⁻+H₂O (9)

H₂O+F⁻⇄HF+OH⁻ (10)

The solid trend line in FIG. 8 represents the behavior predicted for the case where HF and F⁻ associate with Fe^{III}EDTA(H₂O)⁻ with apparent rate constants of 9.3×10⁴ and 4×10⁶ M⁻¹s⁻¹, and are unreactive toward Fe^{III}EDTA(OH)²⁻. See Dellert-Ritter and van-Eldik, J. Chem. Soc., Dalton, 1992, 1037-1044. Fitting the data at pH>6 gives the thermodynamic equilibrium data for hydroxide binding.

### Example 13

### Effects of Superoxide Generating Reagents

A compound that inhibits redox behavior of a metal complex will affect the position of the steady state equilibrium. Addition of a redox reaction substrate(s) will give rise to a different behavior than observed in the absence of the inhibitor. The predicted effects of compounds that inhibit redox reactions of the enzyme SOD on fluoride relaxation under superoxide generating conditions are presented in FIG. 9. The solid line (a) shows behavior previously reported by in the absence of an inhibitor. See Rigo et al., FEBS Letters, 1981, 132, 78-80. Dashed lines (b) and (c) show the behavior predicted in the presence of compounds that inhibit oxidation or reduction of the enzyme, respectively. In contrast, a compound that does not affect redox activity of the complex will not affect the position of the steady state mixture.

A solution was prepared containing fluoride, tfa, phosphate buffer (pH 7.2), and sufficient SOD to give a relaxation rate of 28. Two aliquots of this material were used to prepare NMR samples for superoxide analysis. While both samples contained SOD, only one sample was treated with 2ME2. Both samples were then treated with superoxide generating reagents and the fluoride relaxation rate was measured. In the time required to set up the experiment (i.e., about 10 minutes), the superoxide generating reagents caused the relaxation effect of the enzyme to diminish by more than half (from R₂=28 to 8 s⁻¹ in the absence of 2ME2 and from 28 to 10 s⁻¹ in 100 μM 2ME2). The effect of 2ME2 was not greater than the uncertainty of the measurements. No further change in relaxation rate was observed over the course of several hours. Without being bound to any one theory, the data appears consistent with the establishment of a steady state where the diamagnetic (reduced) form of the enzyme does not contribute to fluoride relaxation and accounts for a little more than half of the total enzyme concentration. The fact that relaxation does not decrease to zero seems to indicate that the reaction is reversible and that a steady state is established where the reduced and oxidized forms of the enzyme are present in similar concentration. The compound 2ME2 does not appear to measurably affect the ratio of the oxidized and reduced enzyme.

### Example 14

### Determination of Metal Centered Reduction Potentials of Metal Complexes

In Example 13, it was demonstrated that the position of metal-centered redox equilibrium can be monitored by NMR if the oxidized and reduced state of the complex differ in their NMR relaxation behaviors. By measuring the relaxation rates of a probe species as a function of electrochemical potential it should therefore be possible to determine the reduction potential of the complex in question. A similar approach was used with electron paramagnetic response (EPR) spectroscopy detection to measure reduction potentials of mutants of FeSOD. See Yikilmaz et al., Biochemistry, 2006, 45, 1151-1161.

### REFERENCES

The references listed below, as well as all references cited in the specification, are incorporated herein by reference to the extent that they supplement, explain, provide a background for, or teach methodology, techniques, and/or compositions employed herein.
Batinic-Haberle, I., et al., Inorg Chem., 1999, 38, 4011-4022.
Bertini, I. et al., Coord. Chem. Rev. 1996, 150, 1-296.
Bloch, J., and Navon, G., J. Inorg. Nucl. Chem., 1980, 42, 693.
Bracco, F., et al., in PET and NMR, New Perspective in Neuroimaging and in Clinical Neurochemistry, Battistin, L., and Gerstenbrand, F., eds., Alan R. Liss, Inc., New York, 1985, pages 315-324.
Braun, S., Kalinowski, H.-O., Berger, S., 150 and More Basic NMR Experiments, Wiley-VCH Weinheim, 1998, page 159.
Bull, C., et al., J. Am. Chem. Soc., 1983, 105, 5290-5300.
Cabelli, D. E., and Bielski, B. H. J., J. Phys. Chem., 1984, 88, 6291.
Danchin, A. Chem. Phys. 1970, 53, 3599-3609.
Dellert-Ritter, M., and van Eldik, R., J. Chem. Soc., Dalton, 1992, 1037-1044.
Dwek, R. A., Nuclear Magnetic Resonance in Biochemistry, Clarendon, Oxford 1973.
Egan, T. J., et al., J. Inorg. Biochem., 1992, 48, 241-249.
Ewing, J. F., and Janero, D. R., Anal. Biochem., 1995, 232, 243-248.
Graf, E., et al., J. Biol. Chem., 1984, 259, 3620-3624.
Heikkila, et al, J. Biol. Chem., 1976, 251, 2182.
Huang, P., et al., Nature, 2000, 407, 390.
Jackson, T. A., et al., Biochemistry, 2005, 44, 1504-1520.
Miller, A.-F., et al., Biochemistry, 2005, 44, 5969-5981.
Pick-Kaplan, M., and Rabani, J., J. Phys. Chem., 1976, 80, 1840.
Rahhal, S., and Richter, H. W., J. Am. Chem. Soc., 1988, 110, 3126-3133.
Rao, U. M., Free Radic. Biol. Med., 1989, 7, 513-519.
Richens, D. T., Chem. Rev., 2005, 105, 1961-2002.
Rigo, A., et al., FEBS Letters, 1981, 132, 78-81.
Rush, J. D., and Cabelli, D. E., Radiat. Phys. Chem., 1997, 49, 661.
Schneppensieper, T., et al., Inorg. Chem., 2001, 40, 3670.
Soulère, L., et al., Bioorg. Med. Chem., 2003, 11, 4941-4944.
Summers, J. S., et al., Inorg. Chem., 2001, 40, 6547.
Summers, J. S., et al., J. Amer. Chem. Soc., 2008, 130, 1727-1734.
U.S. Pat. No. 7,037,660.
Viglino, P., et al., J. Magn. Res., 1979, 34, 265.
Wilkins, R. G., The Study of Kinetics and Mechanism of Reactions of Transition Metal Complexes, Allyn and Bacon, Inc., Boston, 1974, p 272.
Yikilmaz, E., et al., Biochemistry, 2006, 45, 1151-1161.
Zahir, K., et al., J. Am. Chem. Soc., 1988, 110, 5059.
Zehavi, D., and Rabani, J., J. Phys Chem., 1972, 76, 3703.

It will be understood that various details of the presently disclosed subject matter may be changed without departing from the scope of the presently disclosed subject matter. Furthermore, the foregoing description is for the purpose of illustration only, and not for the purpose of limitation.

What is claimed is:

1. A method of predicting a reduction/oxidation (redox) reaction-related activity of a metal complex, said method comprising:
providing a first test solution comprising a metal complex and a probe, wherein said probe comprises a nuclear magnetic resonance (NMR)-active nucleus; and
measuring a signal in the first test solution using NMR spectroscopy to determine a relaxation rate of the NMR-active nucleus, wherein said relaxation rate of the NMR-active nucleus corresponds to the accessibility of a metal atom in the metal complex to the test solution, thereby predicting the redox reaction-related activity of the metal complex.

2. The method of claim 1, further comprising:
providing one or more additional test solutions, wherein each of the one or more additional test solutions comprises the probe and a different concentration of the metal complex;
measuring a signal related to the probe in each of the one or more additional test solutions using NMR spectroscopy, thereby determining a relaxation rate for the NMR-active nuclei in each of the one or more additional test solutions; and
comparing the relaxation rate measured for the NMR-active nucleus in the first test solution with the relaxation rate for the NMR-active nucleus in each of the one or more additional test solutions, thereby determining a sensitivity of the probe to a change in concentration of the metal complex.

3. The method of claim 1, wherein the probe is F⁻.

4. The method of claim 1, wherein the probe comprises phosphorus.

5. The method of claim 1, wherein the metal complex comprises a ligand selected from the group consisting of a protein, a peptide, a carbohydrate, a nucleic acid, a lipid, a low molecular weight natural product, or a combination or a chemically-modified derivative thereof.

6. The method of claim 1, wherein the metal complex comprises a paramagnetic metal ion.

7. The method of claim 1, wherein predicting the redox reaction-related activity of the metal complex predicts the ability of the metal complex to catalyze generation of or to prevent generation of reactive oxygen species (ROS) in one of a cell, a tissue, a biological fluid, and a subject.

8. The method of claim 7, wherein the cell, tissue, biological fluid or subject is associated with a disease state.

9. The method of claim 8, wherein the disease state is related to cancer, an inflammatory disease, a neurological disease, or an infection.

10. The method of claim 1, wherein a plurality of different test solutions is provided, each comprising a different metal complex, and the redox reaction-related activity of each different metal complex is predicted.

11. A method of predicting an effect of a drug candidate on the reduction/oxidation (redox) reaction-related activity of a metal complex, the method comprising:
providing a drug candidate test solution comprising a drug candidate, a metal complex, and a probe, wherein the probe comprises a nuclear magnetic resonance (NMR)-active nucleus;
determining a relaxation rate of the NMR-active nucleus of the probe in the drug candidate test solution to provide a first relaxation rate;
providing a reference solution comprising the probe and the metal complex;
determining the relaxation rate of the NMR-active nucleus of the probe in the reference test solution to provide a second relaxation rate; and
comparing the first and second relaxation rates to determine the effect of the drug candidate on the interaction of the probe and the metal complex, thereby predicting the effect of the drug candidate on the redox reaction-related activity of the metal complex.

12. The method of claim 11, further comprising:
providing one or more additional drug candidate solutions, wherein each of the one or more additional drug candidate solutions comprises the probe, the metal complex, and a different concentration of the drug candidate;
determining a relaxation rate for the NMR-active nucleus of the probe in each of the one or more additional drug candidate test solutions, thereby providing one or more additional relaxation rates; and
comparing the one or more additional relaxation rates with the first and second relaxation rates, thereby determining a predicted inhibitory concentration profile of the drug candidate against the redox-related activity of the metal complex.

13. The method of claim 12, comprising predicting a 50% inhibitory concentration (IC₅₀) for the drug candidate against the redox-related activity of the metal complex.

14. The method of claim 11, wherein the drug candidate comprises a mixture of two or more compounds, each of the two or more compounds having a potential for pharmaceutical activity.

15. The method of claim 11, wherein an effect of each of a plurality of different drug candidates on the redox-related activity of a metal complex is predicted, the method further comprising:
providing one or more additional drug candidate solutions, wherein each of the one or more additional drug candidate solutions comprises the probe, the metal complex, and a different drug candidate;
determining a relaxation rate for the NMR-active nucleus of the probe in each of the one or more additional drug candidate test solutions, thereby providing one or more additional relaxation rates; and
comparing each of the one or more additional relaxation rates with the second relaxation rate.

16. The method of claim 15, wherein the plurality of different drug candidates comprise a molecular library.

17. The method of claim 16, wherein predicting the effect of each of the plurality of different drug candidates screens the molecular library for the presence of one or more compounds that mediate the generation of reactive oxygen species (ROS) in a subject.

18. The method of claim 15, further comprising correlating the presence or absence of structural features in each of the plurality of different drug candidates with the predicted effect of each of the plurality of the different drug candidates on the activity of the metal complex, thereby determining structure activity relationship (SAR) data for the plurality of different drug candidates.

19. The method of claim 18, further comprising determining a 50% inhibitory concentration (IC₅₀) for each of the plurality of different drug candidates against the redox-related activity of the metal complex, and correlating the IC₅₀ for each of the plurality of different drug candidates with the presence or absence of structural features in each of the plurality of different drug candidates, thereby developing quantitative structure activity relationship (QSAR) data for the plurality of different drug candidates.

20. The method of claim 11, wherein the metal complex comprises a ligand selected from the group consisting of a protein, a peptide, a carbohydrate, a nucleic acid, a lipid, a low molecular weight natural product, or a combination or a chemically-modified derivative thereof.

21. The method of claim 11, wherein the metal complex comprises a paramagnetic metal ion.

22. The method of claim 11, further comprising:
providing a second drug candidate test solution, the second drug candidate test solution comprising the probe, the drug candidate, and the metal ion of the metal complex, or a salt thereof;
determining the relaxation rate of the NMR-active nucleus of the probe in the second drug candidate test solution, thereby providing a third relaxation rate;
providing a second reference solution, the second reference solution comprising the probe and the metal ion of the metal complex, or a salt thereof;
determining the relaxation rate of the NMR-active nucleus of the probe in the second reference solution, thereby providing a fourth relaxation rate; and
comparing the difference between the first and second relaxation rates and the difference between the third and fourth relaxation rates; thereby predicting the ability of the drug candidate for displacing the metal ion from the metal complex.

23. A method of assaying a sample to detect the presence of one or more chemical species having an ability to affect the generation of reactive oxygen species (ROS), the method comprising:
providing a test sample, said test sample comprising a probe and at least one metal complex, wherein the at least one metal complex comprises a metal ion and a chemical species associated with the metal ion, and wherein the probe comprises a nuclear magnetic resonance (NMR)-active nucleus;
determining a relaxation rate of the NMR-active nucleus by measuring a signal in the test sample using NMR spectroscopy;
determining a reference relaxation rate of the NMR-active nucleus by measuring a signal in a reference solution, wherein said reference solution comprises the probe and wherein the metal complex is absent;
comparing the relaxation rate of the NMR-active nucleus in the test sample with the reference relaxation rate to determine an effect on relaxation rate caused by the presence of the metal complex; and
determining whether the effect on relaxation rate caused by the presence of the metal complex is consistent with participation of the metal complex in reduction-oxidation (redox) activity, thereby assaying the sample for one or more chemical species having an ability to affect the generation of ROS.

24. The method of claim 23, wherein determining the effect on relaxation rate caused by the presence of the metal complex determines an amount of relaxation rate enhancement caused by the presence of the metal complex.

25. The method of claim 23, wherein the chemical species is a biomolecule selected from the group consisting of a protein, a peptide, a carbohydrate, a nucleic acid, a lipid, a low molecular weight natural product, or a combination or a chemically-modified derivative thereof.

26. The method of claim 23, wherein the metal ion is a paramagnetic metal ion.

27. The method of claim 23, wherein the test sample is a biological sample selected from the group consisting of a cell extract, a tissue extract, or a biological fluid.

28. The method of claim 23, wherein providing the test sample further comprises:
providing a precursor sample comprising one or more different chemical species;
adding a metal ion or a salt thereof to the precursor sample to form one or more different metal complexes, wherein each of the one or more different metal complexes comprises a metal ion and one of the one or more different chemical species; and
adding a probe to the precursor sample.

29. The method of claim 28, wherein the precursor sample comprises a biological sample selected from the group consisting of a cell extract, a tissue extract, or a biological fluid.

30. The method of claim 28, wherein the precursor sample comprises a plurality of different chemical species and adding a metal ion to the precursor forms a plurality of different metal complexes.

31. The method of claim 23, wherein providing the test sample further comprises:
providing a precursor sample mixture comprising a plurality of different chemical species and at least one metal complex;
separating the precursor sample mixture to provide a purified precursor sample, wherein the purified precursor sample comprises one metal complex; and
adding a probe comprising a NMR-active nucleus to the purified precursor sample.

32. The method of claim 31, wherein the separating comprises employing liquid chromatography.

33. The method of claim 31, wherein the precursor sample mixture comprises a plurality of metal complexes, each of the plurality of metal complexes comprising a metal ion and a different chemical species associated therewith; wherein separating the precursor sample mixture provides a plurality of purified precursor samples; and wherein a probe is added to each of the plurality of purified precursor samples to provide a plurality of test samples.

34. The method of claim 33, wherein a relaxation rate is determined for the NMR-active nucleus present in each of the plurality of test samples and compared to the reference relaxation rate, thereby detecting the presence of one or more chemical species having an ability to affect the generation of ROS in each of the plurality of test samples.

35. The method of claim 23, wherein assaying the test sample for one or more chemical species having an ability to affect the generation of ROS further determines that the test sample comprises one or more chemical species or one or more metal complexes that are associated with a disease state.

36. The method of claim 23, wherein the ability to affect the generation of ROS is the ability to prevent the generation of ROS.

37. The method of claim 23, wherein assaying the test sample for one or more chemical species having an ability to affect the generation of ROS further determines that the sample comprises one or more chemical species or one or more metal complexes that can be used in treating a disease associated with generation of ROS.

38. The method of claim 37, wherein the disease associated with generation of ROS is selected from the group consisting of cancer, an inflammatory disease, a neurological disease, and an infection.

39. A method of estimating a reduction/oxidation (redox)-related activity of a metal species using nuclear magnetic resonance (NMR) spectroscopy, the method comprising:
providing a test solution comprising a metal-reactive probe comprising a NMR-active nucleus, a non-metal-reactive internal reference species comprising an NMR-active nucleus, and a metal species;
providing an NMR spectrum by subjecting the test solution to a predetermined pulse sequence;
analyzing the NMR spectrum by comparing one or more resonance integrals of one or more resonance signals related to the probe with one or more resonance integrals of one or more resonance signals related to the internal reference species, thereby determining a ratio of resonance intensities of the probe and reference species; and
analyzing the ratio of resonance intensities to determine whether preferential relaxation occurs for the NMR-active nucleus of the probe as a result of an interaction between the probe and the metal species.

40. The method of claim 39, wherein the predetermined pulse sequence comprises an initial 90 degree pulse sequence followed by a series of 180 degree refocusing pulses.

41. The method of claim 40, further comprising comparing the ratio of resonance intensities to one or more ratio(s) of resonance intensities determined by analyzing an NMR spectrum of one or more of a series of calibration solutions, each of said one or more calibration solutions comprising a metal species having a known redox activity, a probe, and an internal reference species.

42. A method of detecting a catalytic reduction/oxidation (redox) activity of a metal complex, the method comprising:
providing a test solution comprising a probe and a metal complex in a non-steady state initial condition, wherein the non-steady state initial condition is selected from the group consisting of fully oxidized, fully reduced, and partially reduced or oxidized, and wherein the probe comprises a nuclear magnetic resonance (NMR)-active nucleus;
determining a relaxation rate of the NMR-active nucleus in the test solution;
treating the test solution with a redox reaction substrate to provide a treated test solution;
determining a relaxation rate of the NMR-active nucleus in the treated test solution; and
comparing the relaxation rate of the nucleus in the test solution and the relaxation rate of the nucleus in the treated test solution.

43. The method of claim 42, wherein the redox reaction substrate is selected from the group consisting of superoxide, hydrogen peroxide, and a mixture thereof.

44. A method of determining the ability of a compound to inhibit a metal-catalyzed reduction/oxidation (redox) reaction, the method comprising:
providing one or more test samples, each of the one or more test samples comprising a metal complex and a probe comprising a nuclear magnetic resonance (NMR)-active nucleus;
incubating each of the one or more test samples with one or more potential inhibitory compounds;
providing a first reference sample, wherein the first reference sample comprises the metal complex and the probe;
treating the first reference sample and each of the one or more test samples with one or more redox reaction substrates;
allowing the first reference sample and each of the one or more test samples to achieve a steady state condition with regard to the oxidation state of the metal complex;
determining a relaxation rate of the NMR-active nucleus in each of the one or more test samples and in the first reference sample; and
comparing the relaxation rates to determine the effects of the one or more potential inhibitory compounds on the oxidation state of the metal complex.

45. The method of claim 44, further comprising providing a second reference sample, wherein the second reference sample comprises the metal complex and the probe; determining a relaxation rate of a NMR-active nucleus of the probe in the second reference sample to determine the relaxation rate of the NMR-active nucleus in the absence of one or more potential inhibitory compounds and in the absence of one or more redox reaction substrates; and comparing the relaxation rate of the NMR-active nucleus in the second reference sample with the relaxation rate of the NMR-active nucleus in each of the one or more test samples and with the relaxation rate of the NMR-active nucleus in the first reference sample.

46. The method of claim 44, further comprising quantifying the effects of the one or more potential inhibitory compounds on the oxidation state of the metal complex.

47. The method of claim 44, comprising providing a plurality of test solutions and incubating each of the test solutions with one or more different potential inhibitory compounds, thereby screening one or more different potential inhibitory compounds for inhibitory activity.

48. A method of detecting whether a compound inhibits metal complex catalyzed reduction/oxidation (redox) activity via metal atom sequestration, the method comprising:
providing a test sample comprising a metal complex;
contacting the test sample with an inhibitory compound in an amount effective to completely inhibit the redox activity of the metal complex;
adding a probe to the test sample, wherein the probe comprises a nuclear magnetic resonance (NMR)-active nucleus;
determining a relaxation rate of the NMR-active nucleus in the test sample using NMR spectroscopy;
treating the test sample with a metal salt for a period of time, thereby providing a regenerated test sample;
determining the relaxation rate of the NMR-active nucleus in the regenerated test sample; and
analyzing whether the relaxation rate of the NMR-active nucleus in the regenerated test sample indicates restoration of redox activity of the metal complex; thereby determining if the inhibitory compound inhibits the metal complex via metal atom sequestration.

49. The method of claim 48, further comprising dialyzing the test sample against a dialysis solution wherein the inhibitory compound is absent to remove excess inhibitory compound prior to determining the relaxation rate of the NMR-active nucleus in the test sample.

50. The method of claim 48, further comprising removing excess metal salt from the regenerated test sample prior to determining the relaxation rate of the NMR-active nucleus in the regenerated test sample.

51. A method of measuring a metal reduction potential, the method comprising:
providing a test solution comprising a metal complex, a probe comprising a nuclear magnetic resonance (NMR)-active nucleus, and one or more buffer compounds, wherein the one or more buffer compounds are effective for maintaining or altering pH and electrochemical potentials within one or more pre-determined parameters;
measuring an electrochemical potential of the test solution;
determining a relaxation rate of the NMR-active nucleus in the test solution;
treating the test solution to alter the electrochemical potential, thereby providing an altered test solution;
measuring an electrochemical potential of the altered test solution;
determining a relaxation rate of the NMR-active nucleus in the altered test solution; and
correlating changes in relaxation rate with electrochemical potential.

52. The method of claim 51, further comprising repeating the last four steps until an electrochemical potential and a relaxation rate of the NMR-active nucleus in an altered test solution corresponding to each of a plurality of electrochemical potentials within a desired testing range have been measured, determined and correlated.

53. The method of claim 51, wherein measuring the electrochemical potential of the test solution or of the altered test solution is performed by measuring a spectrum of a redox active dye molecule present in the test solution or altered test solution.

54. The method of claim 51, wherein treating the test solution comprises adding one or more chemical oxidants or chemical reductants.

55. A method of screening a plurality of compounds to detect one or more compounds that inhibits the reduction/oxidation (redox) activity of a metal complex by shifting a metal complex reduction potential, the method comprising:
providing one or more reference solutions, each of the one or more reference solutions comprising a metal complex, a probe comprising a nuclear magnetic resonance (NMR)-active nucleus, and one or more buffer components for controlling pH and electrochemical potentials within one or more pre-determined parameters;
providing a plurality of test solutions, each of the plurality of test solutions comprising a metal complex, a probe comprising a NMR-active nucleus, and one or more buffer components for controlling pH and electrochemical potentials within one or more pre-determined ranges;
adding one or more of the plurality of compounds to each of the plurality of test solutions;
establishing a desired electrochemical potential in each of the plurality of test solutions, wherein the desired electrochemical potential approximates a reduction potential of the metal complex;
determining a relaxation rate of the NMR-active nucleus in at least one of the one or more reference solutions and in each of the plurality of test solutions; and
comparing the relaxation rates of the NMR-active nucleus in each of the plurality of test solutions to the relaxation rate of the NMR-active nucleus in the at least one of the one or more reference solutions to determine whether one or more of the plurality of compounds causes a shift in the relaxation of an NMR-active nucleus consistent with a change in an oxidation state equilibrium in the solution.

56. The method of claim 55, wherein the metal complex comprises an enzyme.

57. The method of claim 55, wherein establishing the desired electrochemical potential comprises bulk electrolysis or the addition of an oxidizing or reducing agent.

58. The method of claim 55, wherein at least two reference solutions are provided, and the at least two reference solutions are held at different electrochemical potentials.

59. The method of claim 58, wherein one of the at least two reference solutions is held at the electrochemical potential of an oxidized state of the metal complex and another of the at least two reference solutions is held at the electrochemical potential of a reduced state of the metal complex.
